(19) United States
(12) Patent Application Publication
(10) Pub. No.: US 2026/0120910 A1
(43) Pub. Date: Apr. 30, 2026

(54) ION MOBILITY DEVICE

(71) Applicant: Battelle Memorial Institute, Richland, WA (US)

(72) Inventors: Adam L. Hollerbach, Richland, WA (US); Yehia M. Ibrahim, West Richland, WA (US)

(73) Assignee: Battelle Memorial Institute, Richland, WA (US)

(21) Appl. No.: 18/926,067

(22) Filed: Oct. 24, 2024

(51) Int. Cl. G21K 1/00; G01N 27/622

(52) U.S. Cl. CPC G21K 1/20; G01N 27/622

(57) ABSTRACT

Disclosed herein are aspects of an ion mobility device. In some aspects, the ion mobility device comprises an ion pathway. In some aspects, the ion mobility device comprises a plurality of segmented electrodes arranged in an array that comprises three or more tracks of segmented electrodes, wherein the plurality of segmented electrodes is configured to receive time-varying DC voltages to move ions along the ion pathway. In some aspects, the ion mobility device further comprises a controller configured to charge the plurality of segmented electrodes with a waveform on at least one outer track of the array that is different from a waveform on an inner track of the array to provide at least some lateral confinement of the ions as the ions are moved along the ion pathway. Also disclosed herein are aspects of a method comprising moving ions along an ion pathway.

### STATEMENT AS TO RIGHTS TO DISCLOSURES MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### FIELD

The present disclosure concerns an ion mobility device and a method for moving ions along an ion pathway.

### BACKGROUND

Ion separation and analysis technologies, including ion mobility (IM) spectrometry, can be used to identify the presence, structure, and abundance of different molecules in a sample. However, complex systems, such as biological samples, can include many similar molecules that are challenging to differentiate, such as isomers. Isomeric separations can be important for some analyses, including complex systems such as biological samples that can include many isomers with similar structures. Therefore, there is a need for systems that can separate structurally similar molecules, such as those found in biological samples.

### SUMMARY

Disclosed aspects of the present disclosure advantageously provide an ion mobility device. In some aspects of the present disclosure, the ion mobility device comprises an ion pathway. In some aspects of the present disclosure, the ion mobility device comprises a plurality of segmented electrodes arranged in an array that comprises three or more tracks of segmented electrodes, wherein the plurality of segmented electrodes is configured to receive time-varying DC voltages to move ions along the ion pathway. In some aspects, the ion mobility device further comprises a controller configured to charge the plurality of segmented electrodes with a waveform on at least one outer track of the array that is different from a waveform on an inner track of the array to provide at least some lateral confinement of the ions as the ions are moved along the ion pathway.

Certain disclosed aspects concern a method comprising moving ions along an ion pathway. In some aspects, the ion pathway is defined by an array of segmented electrodes that comprises three or more tracks of segmented electrodes extending along a direction of the ion pathway. In some aspects, the method further comprises at least partially laterally confining the ions as the ions are moved along the ion pathway through the application of different waveforms to different tracks of the segmented electrode array.

The foregoing and other objects, features, and advantages of the present disclosure will become more apparent from the following detailed description, which proceeds with reference to the accompanying figures.

### BRIEF DESCRIPTION OF THE DRAWINGS

FIG. 1 shows a diagram of a system for performing ion manipulation (IM) separations.

FIG. 2A shows a schematic diagram of a structure for lossless ion manipulation (SLIM) with 3-mm-wide guard electrodes.

FIG. 2B shows a schematic diagram of a SLIM layout in which an array of six radiofrequency (RF)×five traveling wave (TW) array of electrodes is inverted to six TW×five RF electrodes in straight legs of an ion pathway, and preserved in portions of the ion pathway where the ion pathway turns.

FIG. 2C shows a schematic diagram of a SLIM layout in which the outer guard electrodes of FIGS. 2A-2B are removed, the width of the inner guard electrode is reduced from 3 mm to 0.4 mm, and the voltage applied to the inner guard electrode is changed from direct current (DC) to RF.

FIG. 2D shows a schematic diagram of a SLIM layout in which the lengths of the TW electrodes are reduced from 1 mm to 0.6 mm and the length of the new RF electrode is extended compared to the SLIM layout of FIGS. 2A-2C.

FIG. 2E shows a schematic diagram of a SLIM layout in which one of the TW tracks is aligned with edges of a panel.

FIG. 2F shows a schematic diagram of a SLIM layout in which the ion pathway is extended to fill the empty space left over by removing the outer guard electrodes. The duty cycles of the waveforms applied to the outermost TW electrodes are also increased from 50% to 75% (six black boxes, two white boxes). The duty cycles of the waveforms applied to the innermost TW electrodes are kept at 50% (four black boxes, four white boxes).

FIG. 3A shows a schematic diagram of eight arrays of six TW electrodes with π/4 phase-shifted rectangular waves possessing 50% duty cycles.

FIG. 3B shows overlaid plots of rectangular waves possessing 50%, 62.5%, 75%, and 87.5% duty cycles.

FIGS. 4A-4D each show a schematic diagram of three sets of 8 TW electrodes using duty cycles of 50%, 62.5%, 75%, and 87.5%, respectively. (Black arrows in FIGS. 4A-23L and 26A-26H indicate the traveling wave's direction of movement.)

FIGS. 5A-5C each illustrate aspects of forward-facing traveling cups formed by applying rectangular waves with 62.5%, 75%, and 87.5% duty cycles, respectively, to outermost TW electrodes and rectangular waves with 50% duty cycles to four innermost TW electrodes.

FIGS. 6A-6C each illustrate aspects of forward-facing traveling cups formed by applying rectangular waves with 50% duty cycles to outermost TW electrodes and rectangular waves with 37.5%, 25%, and 12.5% duty cycles, respectively, to four innermost TW electrodes.

FIGS. 7A-7D each illustrate aspects of forward-facing traveling cups formed by applying rectangular waves with 62.5% duty cycles to outermost TW electrodes and rectangular waves with 50%, 37.5%, 25%, and 12.5% duty cycles, respectively, to four innermost TW electrodes.

FIGS. 8A-8E each illustrate aspects of forward-facing traveling cups formed by applying rectangular waves with 75% duty cycles to outermost TW electrodes and rectangular waves with 62.5%, 50%, 37.5%, 25%, and 12.5% duty cycles, respectively, to four innermost TW electrodes.

FIGS. 9A-9F each illustrate aspects of forward-facing traveling cups formed by applying rectangular waves with 87.5% duty cycles to outermost TW electrodes and rectangular waves with 75%, 62.5%, 50%, 37.5%, 25%, and 12.5% duty cycles, respectively, to four innermost TW electrodes.

FIGS. 10A-10D each illustrate aspects of traveling V-shaped forward-facing cups formed by applying rectangular waves with duty cycles to outermost, middle, and innermost TW electrodes of 50%/37.5%/25%, 62.5%/50%/37.5%, 75%/62.5%/50%, and 87.5%/75%/62.5%, respectively.

FIGS. 11A-11D each illustrate aspects of traveling V-shaped forward-facing cups formed by applying rectangular waves with duty cycles to outermost, middle, and innermost TW electrodes of 62.5%/37.5%/12.5%, 75%/50%/25%, 87.5%/62.5%/37.5%, 87.5%/50%/12.5%, respectively.

FIGS. 12A-12C each illustrate aspects of backwards-facing traveling cups formed by applying rectangular waves with 62.5% & 3π/4, 75% & π, and 87.5% & π/4, respectively, duty cycles and phase-shifts to outermost TW electrodes, and rectangular waves with 50% & π duty cycles and phase-shifts to four innermost TW electrodes.

FIGS. 13A-13D each illustrate aspects of backwards-facing traveling cups formed by applying rectangular waves with 62.5% (+3π/4) duty cycles (and phase shifts) to outermost TW electrodes and rectangular waves with 50% (+π), 37.5% (+5π/4), 25% (+3π/2), and 12.5% (+7π/4) duty cycles (and phase shifts), respectively, to four innermost TW electrodes.

FIGS. 14A-14E each illustrate aspects of backwards-facing traveling cups formed by applying rectangular waves with 75% (+π/2) duty cycles (and phase shifts) to outermost TW electrodes and rectangular waves with 62.5% (+3π/4), 50% (+π), 37.5% (+5π/4), 25% (+3π/2), and 12.5% (+7π/4) duty cycles (and phase shifts), respectively, to four innermost TW electrodes.

FIGS. 15A-15F each illustrate aspects of backwards-facing traveling cups formed by applying rectangular waves with 87.5% (+π/4) duty cycles (and phase shifts) to outermost TW electrodes and rectangular waves with 75% (+π/2), 62.5% (+3π/4), 50% (+π), 37.5% (+5π/4), 25% (+3π/2), and 12.5% (+7π/4) duty cycles (and phase shifts), respectively, to four innermost TW electrodes.

FIGS. 16A-16D each illustrate aspects of backwards-facing V-shaped traveling cups formed by applying rectangular waves with duty cycles (and phase shifts) of 50%/37.5%/25% (+π/+5π/4/+3π/2), 62.5%/50%/37.5% (+3π/4/+π/+5π/4), 75%/62.5%/50% (+π/2/+3π/4/+π), 87.5%/75%/62.5% (+π/4/+π/2/+3π/4), respectively, to outermost, middle, and innermost TW electrodes.

FIGS. 17A-17D each illustrate aspects of backwards-facing V-shaped traveling cups formed by applying rectangular waves with duty cycles (and phase shifts) of 62.5%/37.5%/12.5% (+3π/4/+5π/4/+7π/4), 75%/50%/25% (+π/2/+π/+3π/2), 87.5%/62.5%/37.5% (+π/4/+3π/4/+5π/4), and 87.5%/50%/12.5% (+π/4/+π/+7π/4), respectively, to outermost, middle, and innermost TW electrodes.

FIGS. 18A-18D each illustrate aspects of symmetric traveling cups formed by applying rectangular waves with duty cycles (and phase shifts) of 50%/25% (+0/+π/4), 62.5%/37.5% (+0/+π/4), 75%/50% (+0/π/4), and 87.5%/62.5% (+0/+π/4,), respectively, to outermost and innermost TW electrodes.

FIGS. 19A-19D each illustrate aspects of symmetric traveling cups formed by applying rectangular waves with duty cycles (and phase shifts) of 62.5%/12.5% (+0/+π/2), 75%/25% (+0/+π/2), 87.5%/37.5% (+0/π/2), and 87.5%/12.5% (+0/+3π/4), respectively, to outermost and innermost TW electrodes.

FIGS. 20A-20C illustrate aspects of V-shaped symmetric traveling cups formed by applying rectangular waves with duty cycles (and phase shifts) of 62.5%/37.5%/12.5% (+0/+π/4/+π/2), 75%/50%/25% (+0/+π/4/+π/2), and 87.5%/62.5%/37.5% (+0/+π/4/+π/2), respectively, to outermost, middle, and innermost TW electrodes, respectively.

FIGS. 21A-21D each illustrate aspects of asymmetric traveling cups formed by applying a rectangular wave with 62.5% duty cycle and +0 phase shift to outermost TW electrodes and a rectangular wave with a duty cycle (and phase shift) of 12.5% (+π/4), 12.5% (+3π/4), 25% (+π/4), and 25% (+π/2), respectively, to innermost TW electrodes.

FIGS. 22A-22H each illustrate aspects of asymmetric traveling cups formed by applying a rectangular wave with 75% duty cycle and +0 phase shift to outermost TW electrodes and a rectangular wave with a duty cycle (and phase shift) of 37.5% (+π/4), 37.5% (+π/2), 25% (+π/4), 25% (+3π/4), 12.5% (+π/4), 12.5% (+π/2), 12.5% (+3π/4), and 12.5% (+π), respectively, to innermost TW electrodes.

FIGS. 23A-23L each illustrate aspects of asymmetric traveling cups formed by applying a rectangular wave with 87.5% duty cycle and +0 phase shift to the outermost TW electrodes and a rectangular wave with a duty cycle (and phase shift) of 50% (+π/4), 50% (+π/2), 37.5% (+π/4), 37.5% (+3π/4), 25% (+π/4), 25% (+π/2), 25% (+3π/4), 25% (+π), 12.5% (+π/4), 12.5% (+π/2), 12.5% (+π), 12.5% (+3π/2), respectively, to innermost TW electrodes.

FIG. 24 shows a flow diagram of an example method for moving ions along an ion pathway.

FIG. 25 shows a schematic diagram of an example computing system.

FIG. 26A shows a potential energy surface for a moving wall of traveling waves.

FIG. 26B shows a potential energy surface for a forward-facing cup using 75% duty cycles applied to outermost TW electrodes and 50% duty cycle applied to four innermost TW electrodes.

FIG. 26C shows a potential energy surface for a symmetric cup using 75% duty cycles applied to the outermost TW electrodes and 50% duty cycle applied to four innermost TW electrodes.

FIG. 26D shows a potential energy surface for a backward-facing cup using 75% duty cycles applied to the outermost TW electrodes and 50% duty cycle applied to four innermost TW electrodes.

FIG. 26E shows a potential energy surface for a forward-facing cup using 87.5% duty cycles applied to the outermost TW electrodes and 50% duty cycle applied to four innermost TW electrodes.

FIG. 26F shows a potential energy surface for an asymmetric cup using 87.5% duty cycles applied to the outermost TW electrodes and 50% duty cycle applied to four innermost TW electrodes.

FIG. 26G shows a potential energy surface for an asymmetric cup using 87.5% duty cycles applied to the outermost TW electrodes and 50% duty cycle applied to four innermost TW electrodes.

FIG. 26H shows a potential energy surface for a backward-facing cup using 87.5% duty cycles applied to the outermost TW electrodes and 50% duty cycle applied to four innermost TW electrodes.

FIG. 27 shows ion trajectory simulations of various SLIM configurations using 50% duty cycle rectangular waves applied to all TW electrodes and a +10 V_{dc}, −10 V_{dc}, and −20 V_{dc} guard voltage. Ion trajectory simulations are also illustrated using forward-facing cups that are formed by applying a rectangular wave with 75% duty cycle to the outermost TW electrodes and a rectangular wave with a 50% duty cycle to innermost TW electrodes and a −10 V_{dc} guard voltage and a −20 V_{dc} guard voltage. Ion trajectory simulations are also illustrated using symmetric cups that are formed by applying a rectangular wave with a 75% duty cycle to the outermost TW electrodes and a rectangular wave with a 50% duty cycle to innermost TW electrodes and a −10 V_{dc} guard voltage and a −20 V_{dc} guard voltage. Ion trajectory simulations are also illustrated using backward-facing cups that are formed by applying a rectangular wave with a 75% duty cycle to the outermost TW electrodes and a rectangular wave with a 50% duty cycle to innermost TW electrodes and a −10 V_{dc} guard voltage and a −20 V_{dc} guard voltage.

FIG. 28 shows ion trajectory simulations of a various SLIM configurations using rectangular waveforms with 87.5% and 50% duty cycles applied to the outermost and innermost TW electrodes, respectively. Forward-facing cups, asymmetric cups, and backward-facing cups are formed and guard voltages of −10 V_{dc} and −20 V_{dc} are applied to respective examples.

FIGS. 29A-29B show ion trajectory simulations of two adjacent ion pathways using rectangular waveforms with 50% duty cycles applied to the outermost and innermost TW electrodes, with +10 V applied to the middle electrode and +RF applied to the middle electrode, respectively.

FIGS. 29C-29E each show an ion trajectory simulation of two adjacent ion pathways using rectangular waveforms with 75% and 50% duty cycles applied to the outermost and innermost TW electrodes (respectively) in a form of forward-facing traveling cups (29C), symmetric traveling cups (29D), and backward-facing traveling cups (29E), respectively. A positive RF is applied to the middle electrode separating the two adjacent ion pathways.

FIGS. 30A-30D each show ion trajectory simulations of two adjacent ion pathways using rectangular waveforms with 87.5% and 50% duty cycles applied to the outermost and innermost TW electrodes (respectively), in a form of forward-facing traveling cups (30A), in a form of asymmetric traveling cups (30B), in another form of asymmetric traveling cups (30C), and in a form of backwards-facing traveling cups (30D), respectively. A positive RF is applied to the middle electrode separating the two adjacent ion pathways.

FIG. 31A shows a plot of a simulation workspace of a U-turn with a segmented RF electrode in the middle of the workspace (highlighted by a black arrow).

FIGS. 31B-31D each show ion trajectory simulations of ions transferring through the U-turn of FIG. 28A using +10 V, +20 V, and +50 V, respectively, applied to a leftmost portion of the segmented RF electrode. All simulations were performed using SLIM traveling wave parameters (i.e., 50% duty cycle rectangular waves).

FIGS. 32A-32C are respective plots of arrival time distributions of ion trajectory simulations performed using +10 V, +20 V, and +50 V, applied to the leftmost portion of the middle electrode. Black arrows indicate regions where additional peaks are observed but exhibit low intensity.

FIGS. 33A-33L show ion trajectory simulations of ions transferring through a U-turn using forward-facing traveling cups, symmetric traveling cups, and backward-facing traveling cups and when applying +0 phase shifts, +π/4 phase shifts, +π/2 phase shifts, and +3π/4 phase shifts to each 90° turn.

FIGS. 34A-34L show plots of arrival time distributions obtained from ion trajectory simulations performed using a U-turn and forward-facing traveling cups, symmetric traveling cups, and backward-facing traveling cups when using +0 phase shifts, +π/4 phase shifts, +π/2 phase shifts, and +3π/4 phase shifts at each 90° turn. Black arrows indicate regions where additional peaks are observed but exhibit low intensity.

### DETAILED DESCRIPTION

### I. Abbreviations

AP: atmospheric pressure; cm: centimeter; DC: direct current; DT: drift tube; IM: ion mobility; km: kilometer; mm: millimeter; PCB: printed circuit board; RF: radiofrequency; SLIM: structures for lossless ion manipulations; TW: traveling wave; V: Volt

### II. Overview of Terms, Ranges, and Definitions

Both the foregoing general description and the following detailed description are exemplary and explanatory only and are not intended to limit the scope of the present disclosure.

As used herein, the use of the singular includes the plural unless specifically stated otherwise. For example, the singular forms “a”, “an” and “the” as used in the specification also include plural aspects unless the context dictates otherwise. Similarly, any singular term used in the specification also means plural or vice versa, unless the context dictates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

The disclosure of numerical ranges should be understood as referring to each discrete point within the range, inclusive of endpoints, unless otherwise noted. Unless otherwise indicated, all numbers expressing quantities of ingredients, properties such as molecular weight, percentages, and so forth, as used in the specification or claims are to be understood as being modified by the term “about.” Accordingly, unless otherwise implicitly or explicitly indicated, or unless the context if properly understood by a person of ordinary skill in the art (with the benefit of the present disclosure) to have a more definitive construction, non-numerical properties such as amorphous, continuous, crystalline, homogeneous, and so forth as used in the specification or claims are to be understood as being modified by the term “substantially,” meaning to a great extent or degree. Accordingly, unless otherwise indicated, implicitly or explicitly, the numerical parameters and/or non-numerical properties set forth are approximations that may depend on the desired properties sought, limits of detection under standard test conditions/methods, limitations of the processing method, and/or the nature of the parameter or property. When directly and explicitly distinguishing example from discussed prior art, the disclosed numbers are not approximates unless the word “about” is recited.

The term “or combinations thereof” as used herein refers to all permutations and combinations of the listed items preceding the term. For example, “A, B, C, or combinations thereof” is intended to include at least: A, B, C, AB, AC, BC, or ABC, and if order is important in a particular context, also BA, CA, CB, ACB, CBA, BCA, BAC, or CAB. Continuing with this example, expressly included are combinations that contain repeats of one or more item or term, such as BB, AAA, AAB, BBC, AAABCCCC, CBBAAA, CABABB, and so forth.

The term “adjacent”refers to something that is next to or adjoining another thing.

The term “array” refers to a two- or three-dimensional arrangement of a plurality of electrodes. In some aspects, a two-dimensional array comprises electrodes arranged in rows and columns (including single rows or single columns).

The term “charge” refers to applying an electrical potential (also known as a voltage) to an object, such as an electrode. In some aspects, the electrical potential is a direct current voltage (V_{dc}) or an alternating current voltage. In some aspects, the electrical potential can oscillate at a radio frequency (RF), or the electrical potential can be otherwise used to induce an oscillating magnetic, electric, or electromagnetic field with an RF oscillation rate.

The term “connecting bend” refers to a segment of an ion pathway that joins, unites, or links, two or more different portions of an ion pathway.

The term “controller” refers to a structure or a device that is configured to operate at least a portion of an ion mobility device, and/or that is configured to carry out at least a portion of a method for moving ions along an ion pathway. A controller typically includes a processor and memory configured with processor executable instructions to cause controlling operation.

The term “duty cycle” refers to a percentage or a ratio of pulse duration or pulse width to a period of a waveform. In some aspects, the duty cycle refers to a ratio of time that an electrode is charged compared to a time the electrode is disconnected or is charged with an inverse potential, which can be expressed as a percentage.

The term “electrode” refers to an electrically conductive material configured to be charged with an electrical potential, and which is configured to establish an electrical field. The term “traveling wave electrode” or “TW electrode” refers to an electrode that is configured to provide an electrical field that propels ions along an ion pathway. The term “radiofrequency electrode” or “RF electrode” refers to an electrode that is charged with RF power and/or which generates an RF field. The term “guard electrode” refers to an electrode that is configured to generate an electrical field that provides at least some lateral confinement of the ions to the ion pathway. In some aspects, the guard electrode is charged with a DC voltage (V_{dc}).

The term “incremented” refers to an increase in a value. In some aspects, the value is increased by a discrete amount.

The term “ion” refers to an atom or molecule with a net electric charge.

The term “ion mobility device” refers to a device that is configured to move ions.

The term “ion pathway” refers to a predetermined route or a predetermined direction in which one or more ions are moved.

The term “lateral confinement” refers to binding, constraining, or containing ions within sides of an ion pathway. In some aspects, the lateral confinement is affected by providing a repulsive force in a direction perpendicular to the ion pathway.

The term “leg” refers to at least a portion of the ion pathway. In some aspects, the leg forms an appendage that extends from another portion of the ion pathway.

The term “phase shift” refers to a change in a phase of a waveform. In some aspects, the phase shift takes the form of a horizontal shift of a periodic function, or a displacement of the periodic function in time.

The term “radiofrequency” or “RF” refers to an oscillation rate in a radio spectrum. In some aspects, the oscillation rate is in a range of 20 kHz to 300 GHz. In some aspects, RF additionally or alternatively refers to electromagnetic radiation (EMR) that transfers energy by radio waves.

The term “track” refers to a plurality of electrodes grouped in a linear arrangement along at least a portion of an ion pathway. In some aspects, the plurality of electrodes are configured to be charged with a periodic function with respect to a length of the track. The term “outer track” refers to a track that is adjacent to a lateral side of the ion pathway, or a track that is closer to the lateral side of the ion pathway relative to another track. The term “inner track” refers to a track that is closer to a centerline of the ion pathway than another track. The term “intermediate track” refers to a track that is located between at least one outer track and at least one inner track.

The term “traveling wave” or “TW” refers to a wave that moves through a medium.

The term “waveform” refers to a configuration of a wave that indicates characteristics of the wave, such as frequency and amplitude, and a shape of the wave. Some examples of wave shapes include square waves, rectangular waves, triangle waves, and sinusoidal waves.

The term “traveling wave set” refers to a plurality of traveling waves that make up a group.

### III. Introduction

As introduced above, separations using ion mobility (IM) spectrometry can be used to distinguish between structurally similar molecules. However, it can be challenging to separate between large numbers of similar molecules in complex systems, such as biological samples, which may include many isomers with similar structures.

In some instances, resolving power can be increased by increasing the pressure inside the instrument. IM systems operating at atmospheric pressure (AP) can yield relatively high resolution compared to other available IM systems (other than cyclic IM techniques, such as SLIM). Many AP-IM systems are based on a stacked ring ion-guide design, also called a drift tube (DT). AP-DTIM systems can be up to about 20 cm long and may operated in tandem with a mass spectrometer or as stand-alone (and/or portable) systems. Some AP-IM systems can achieve approximately 255 resolving powers. Increasing the pressure in an IM spectrometer can improves its resolving power by increasing a frequency of collisions between ions and the buffer gas relative to low pressure systems. However, increasing pressure can lead to adverse effects on other aspects of IM spectroscopy, such as by slowing analysis time and by increasing ion scattering and reducing ion transmission, which can reduce the signal-to-noise ratio. Furthermore, RF confinement can become less efficient as pressure is increased (up to the point where it can no longer contain the ions). This can cause elevated-pressure-based IM systems to suffer from low sensitivity.

Another way to increase the resolving power in an IM instrument is to increase the electric field strength. AP-IM systems can also use higher electric field strengths to achieve higher resolving powers than other IM instruments. However, electric field strengths cannot be increased indefinitely. Eventually, arcing can occur when the breakdown potential of the buffer gas medium (e.g., air) is reached. Therefore, there is a maximum voltage (and electric field strength) that can be reached in any IM system.

In some instances, ions can be separated with higher resolution by increasing the path length of the IM device. The longer ions travel, the more time they have to separate. Generally, the resolution of an IM spectrometer scales by the square root of the path length. This means that if the path length is increased by 1.5×, then the resolution should increase by √1.5≈1.22×. In some instances, structures for lossless ion manipulations (SLIM) exploit this relationship between path length and resolution by using serpentine paths to create long and winding path lengths that fit into a fraction of a space that would be required if the path lengths were stretched into a straight line. Multilevel SLIM systems can also be produced.

For instance, a SLIM device can be created using one or more printed circuit boards (PCBs) that are 0.5 meters long and 0.3 meters wide, while an equivalent length device using a straight path would take up 11 meters of continuous laboratory space. Devices with this length that utilize DC voltage gradients can suffer from issues including voltage limitations.

Cyclic IM systems can send ions through a cell multiple times before allowing the ions to exit. Cycling ions around the same track multiple times creates a long “effective” path length, meaning the distance ions travel can be long while the track itself is not necessarily as long. For example, ions can be cycled multiple times around a one-meter-long path to create a longer effective path length (e.g., 16 meters) before ion lapping occurs. SLIM can use >10 meter path length cyclic IM cells to achieve high resolving powers. Cycling ions in a multilevel SLIM system (e.g., from a bottom level back to a top level) can further increase the effective path length. However, cyclic experiments can take a long time to scan across an entire mobility range. Methods to further increase the path length available in small footprints without cycling have the potential to create more powerful IM systems that can be used to differentiate structurally similar molecules, such as those found in biological samples.

Accordingly, disclosed examples advantageously provide an IM device comprising a plurality of segmented arranged in an array. In some aspects, the plurality of segmented electrodes is configured to receive time-varying DC voltages to move ions along an ion pathway. In some aspects, the plurality of segmented electrodes are operated with a waveform on at least one outer track of the array that is different from a waveform on an inner track of the array to provide at least some lateral confinement of the ions as the ions are moved along the ion pathway. The use of different waveforms to provide at least some lateral confinement of the ions enables the ion mobility device to operate without separate guard electrodes to provide the lateral confinement, or with smaller guard electrodes than existing IM systems. This can enable ion pathways to be packed closer together than in the existing IM systems, which allows a longer ion pathway to be wrapped within the same spatial boundary as the existing IM systems.

### IV. System for Performing IM Separations

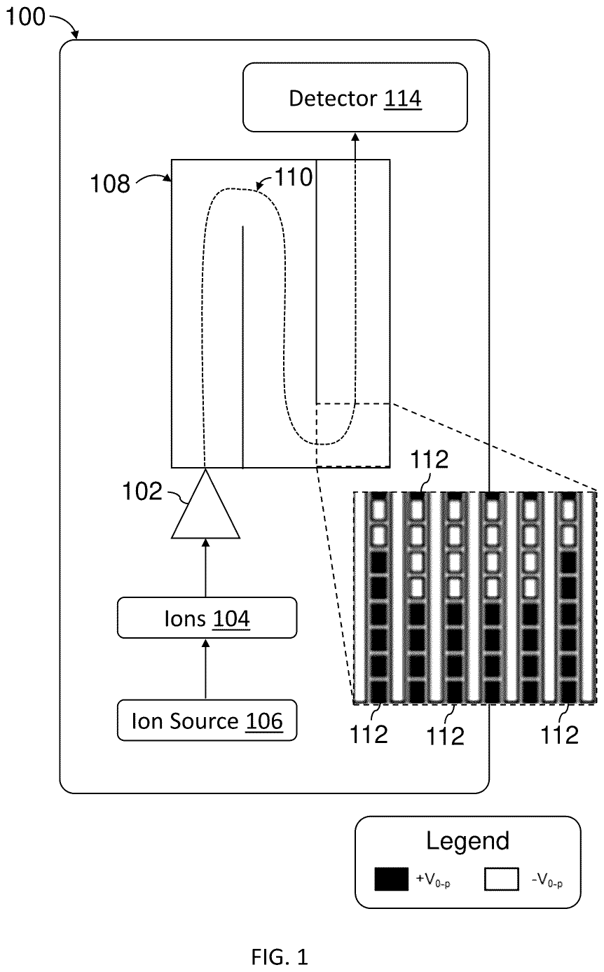

FIG. 1 shows a system 100 that can perform IM separations. The system 100 includes an input 102 configured to receive a plurality of ions 104 from an ion source 106. In some examples, the ion source 106 comprises an ionization chamber. The ionization chamber is configured to ionize one or more input atoms or molecules by applying energy (e.g., in an electric field or through heat) to convert the one or more input atoms or molecules into the one or more ions 104 which can be separated and analyzed by IM spectroscopy.

The ions 104 are provided to an IM device 108 from the input 102. As described in more detail below, the IM device 108 comprises an ion pathway 110. The ions 104 are moved along the ion pathway 110 by a plurality of segmented electrodes 112, a portion of which is shown in an inset in FIG. 1 with another portion (not shown) being situated above or below to define the region of the ion pathway 110 through which the ions move. In some examples, the segmented electrodes 112 can be referred to as traveling wave (TW) electrodes, which can be situated to receive an electric charge according to a traveling waveform such that at least a portion of the plurality of segmented electrodes 112 repel the ions 104 and/or at least another portion of the plurality of segmented electrodes 112 attract the ions. For example, as indicated by a legend in FIG. 1, segmented electrodes 112 depicted with black fill are positively charged (which repel positively charged ions 104) while segmented electrodes 112 depicted with white fill are negatively charged (which attract the positively charged ions 104). As a result of the traveling waveform moving along a direction of the ion pathway 110, the ions 104 are propelled through the IM device 108.

In some examples, the ions 104 are directed to a detector 114 after reaching an opposite end of the ion pathway 110. Any suitable detector can be used. Some examples of suitable detectors include electron multipliers, ion-to-photon detectors, Faraday cup detectors, and microchannel plate detectors. This can allow for identification of analyte atoms or molecules as they emerge from the IM device 108. Additional detector examples can include mass spectrometers or other instruments.

### V. IM Device Geometry

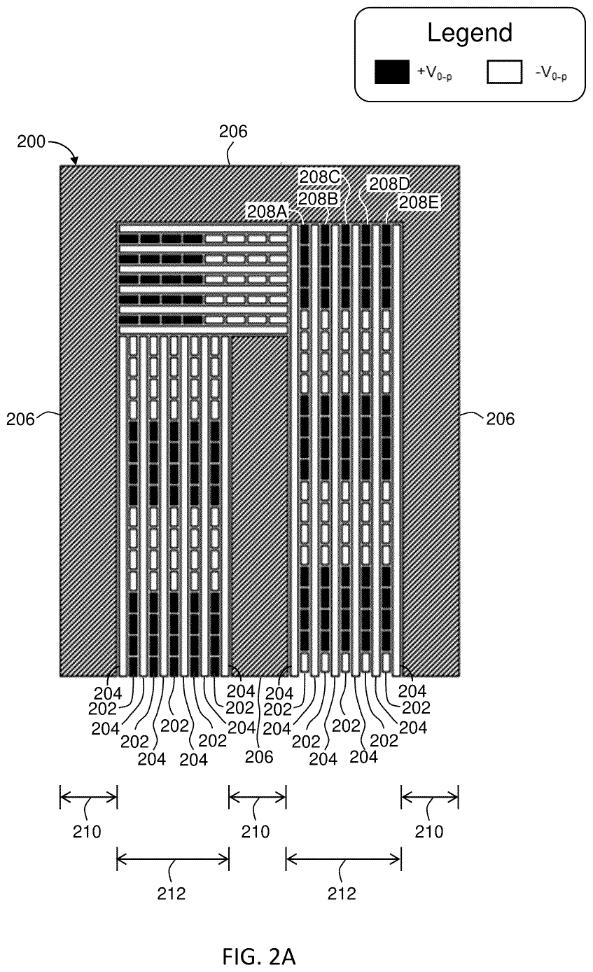

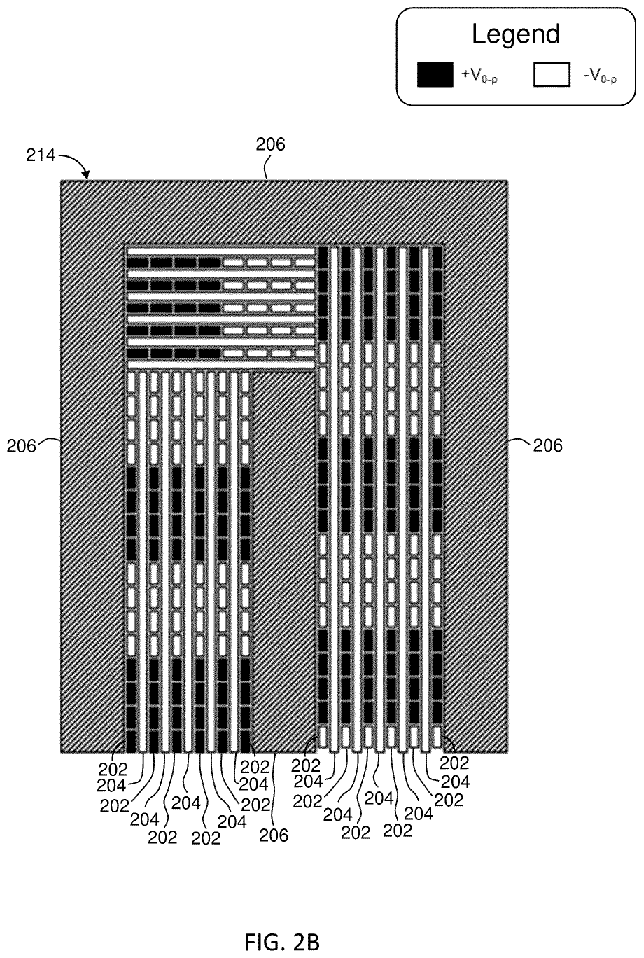

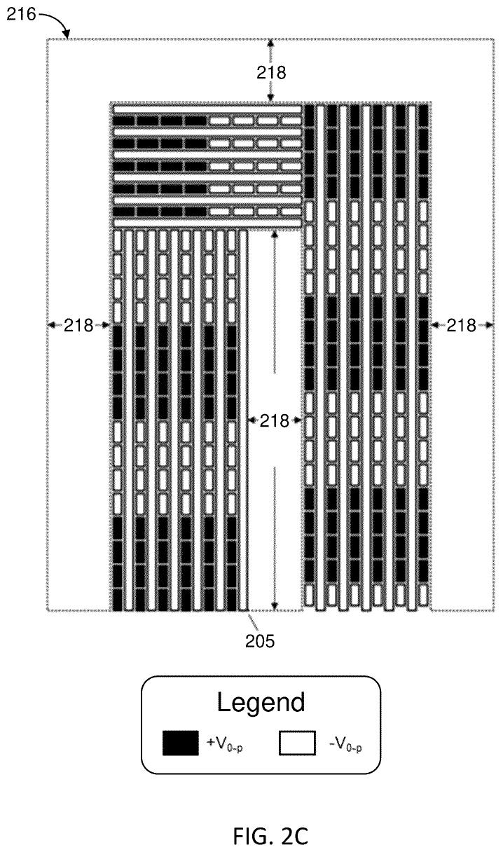

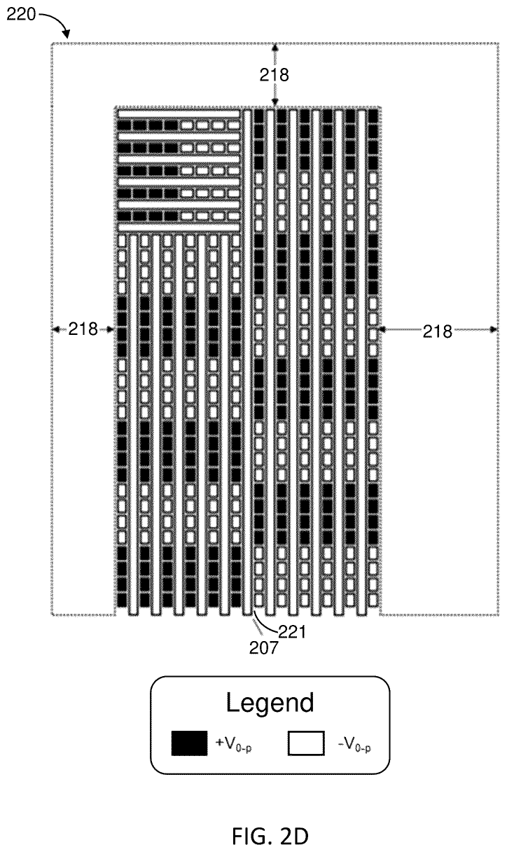

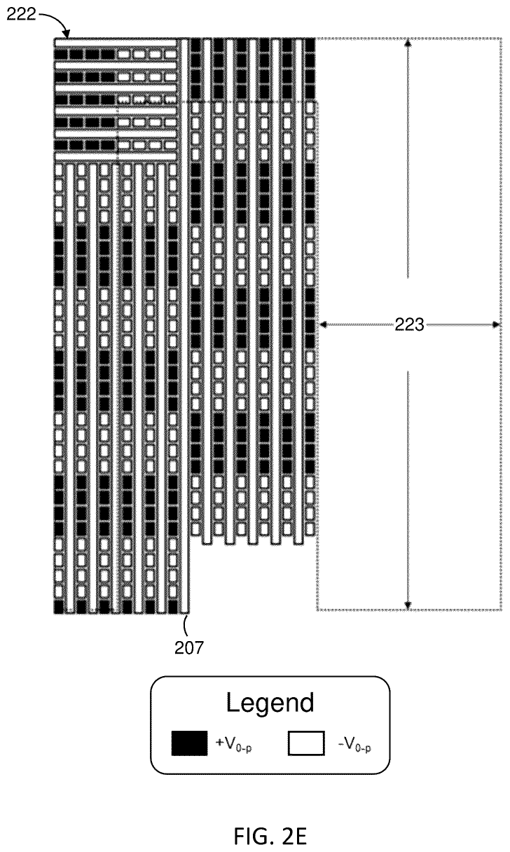

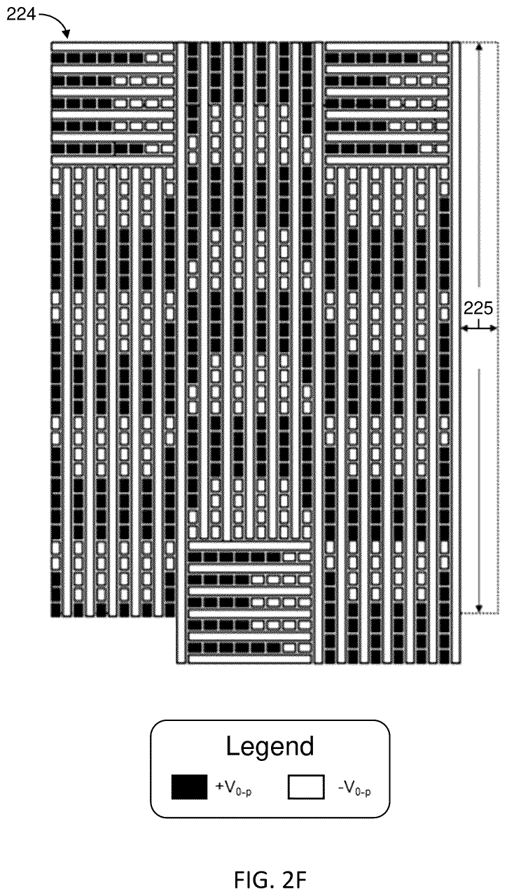

FIG. 2A shows another example of an IM device 200. In some examples, IM separations are performed using three independent types of electrodes: TW electrodes 202, radiofrequency (RF) electrodes 204, and guard electrodes 206. In some examples, the TW electrodes 202 comprise segmented electrodes arranged in an array that comprises a plurality of tracks 208A-208E. An opposing set of TW electrodes, RF electrodes, and guard electrodes (not shown for clarity) can be spaced apart from the TW electrodes 202, RF electrodes 204, and guard electrodes 206 (e.g., above or below the plane of FIG. 2A) to define a region through which ions may be moved. Other described examples typically include opposing sets of electrodes as well.

As introduced above, in some aspects, the TW electrodes 202 are electrically charged with a traveling waveform configured to move ions in a direction of the tracks 208A-208E. For example, as indicated in FIG. 2A, a portion of the TW electrodes 202 are positively charged with a potential +V₀₋ₚ (which repel positively charged ions) and another portion of the TW electrodes 202 are negatively charged with a potential −V₀₋ₚ (which attract positively charged ions). In some aspects, at least a portion of the TW electrodes 202 can be neutral or de-energized by the traveling waveform, or can have an intermediate potential between +V₀₋ₚ and −V₀₋ₚ. In many examples, similar potentials can be applied to the opposing tracks. As a result of the traveling waveform moving along the tracks 208A-208E and opposing tracks, the ions are propelled through the IM device 200. In some aspects, application of RF power to one or more of the RF electrodes 204 can help confine the ions to an ion pathway defined at least partially by the TW electrodes 202, and prevent the ions from hitting other surfaces of a substrate on which the IM device 200 is formed. In typical examples, adjacent ones of the RF electrodes 204 receive the same RF potential but that is 180 degrees out of phase.

In some aspects, the guard electrodes 206 are energized with a DC potential to ensure that ions do not move sideways and leave the ion pathway defined at least partially by the TW electrodes 202 (which can be referred to as ‘lateral’ confinement). In some aspects, if guard electrodes 206 are not present, ions can hop between adjacent ion pathways instead of maintaining travel along a desired ion pathway. Deleterious effects can occur if ions are allowed to jump between ion pathways, such as the appearance of multiple peaks at an ion detector that originate from the same input ion cloud. For example, ions that jump between ion pathways can travel across less path length than they are intended to travel, and this can result in reduced detected ion mobility resolution due to the dependence of resolution on path length traveled.

In some existing IM devices, guard electrodes 206 are employed that have a width 210 of 3 mm or greater and can prevent ions from jumping the ion pathway where the ion pathway turns. Electrode geometries in such devices can be optimized to use compact arrays to create long path lengths, however increasing the path lengths further without making the instrument size larger has thus far proven elusive.

The example of the IM device 200 shown in FIG. 2A has a layout forming a U-turn. This layout includes an interleaved array of six of the RF electrodes 204 with five of the TW electrodes 202 spaced 0.15 mm apart. In some aspects, the RF 204 and TW electrodes 202 are both 0.4 mm wide, and the TW electrodes 204 are 1 mm long. In some aspects, a total width 212 of the RF and TW array of electrodes is 5.9 mm (excluding 0.15 mm spacings on each side). The layout in FIG. 2A also shows guard electrodes 206 that are 3 mm wide (designated with closely spaced diagonal lines). In some aspects, a larger path length can be accommodated if the guard electrodes 206 are shrunk or removed.

In some aspects, one or more independent guard electrodes 206 (which operates on DC) are removed and replaced with an RF electrode. In some aspects, the RF electrode that replaces the one or more DC guard electrodes 206 has a width of less than 3 mm. In some aspects, the width is in a range of 0.1 mm-1 mm. In some aspects, the width is in a range of 0.4 mm-0.5 mm. Replacing the 3 mm guard electrode with a 0.4 mm RF electrode, for example, results in 1.5× more space on a substrate (e.g., a PCB) where the ion path can be extended. In many examples, parallel ion paths can additionally or alternatively occupy space freed up by shrinking or removing the guard electrodes. Examples of such RF electrodes replacing the guard electrodes 206 can be found in FIGS. 2D-2F which are described further below.

Using FIG. 2A as an example, removing the guard electrodes 206 would free up 9 mm of space. Because the array of RF and TW electrodes 204, 202 are 5.9 mm wide, this would allow for about 1.5 new tracks to be used in the same space. For example, in an IM device with 10 meters of path length in a small area, increasing the path length by 1.5× can yield 15 meters of path length in the same area.

To maintain lateral confinement without the guard electrodes 206, in some aspects, a positioning of the RF and TW electrodes 204, 202 can be inverted and quantity adjusted. For example, with reference to FIG. 2B an IM device 214 is shown with TW electrodes 202 (and corresponding TW tracks) at positions of the RF electrodes 204 shown in FIG. 2A, and similarly, with RF electrodes 204 at positions of the TW electrodes 202 (and corresponding TW tracks) of shown in FIG. 2B. This can manifest in an interleaved array of six TW electrodes (and tracks) and five RF electrodes, whereas the array of FIG. 2A comprises six RF electrodes and five TW electrodes.

In some example IM devices, an inversion of RF and TW electrodes can be applied only to straight legs of the ion pathway, while portions of the ion pathway that turn or define a turn can possess the same original arrangement of TW and RF electrodes as illustrated in FIG. 2A (i.e., six RF×five TW electrodes) or a different arrangement.

FIG. 2C shows another example of an IM device 216 that does not include outer guard electrodes (e.g., in which all of the outer guard electrodes 206 surrounding the ion track are removed), and an RF electrode 205 having a width of 0.4 mm in the place of an inner guard electrode (such as by replacing the inner guard electrodes 206 with RF electrodes 204). In some aspects, this generates white (empty) space 218. After removing the guard electrodes, the ion pathways can be brought closer together.

FIG. 2D shows aspects of an IM device 220 in which the electrode tracks are moved closer together than in the configurations of FIGS. 2A-2C. In some aspects, the amount of white (empty) space 221 in the middle of the SLIM track is reduced or eliminated. In some aspects, a new RF electrode 207 can replace the inner guard electrode 206 of FIGS. 2A-2B. The RF electrode 207 can be similar to the RF electrodes 204, 205 in various ways (such as width, phase alternation, etc.) and can be lengthened so that it spans an entire ion track (rather than intersecting with another electrode at a 90° turn as illustrated with RF electrode 205 in FIG. 2C). In some aspects, the length of the TW electrodes is shrunk from 1 mm to 0.6 mm as compared to the configurations of FIGS. 2A-2C. Other examples can include different TW electrode lengths, e.g., 0.8 mm, 0.4 mm, etc. The reduction in TW electrode length can depend on the width of the array of TW and RF electrodes. While FIG. 2A shows an example with an array of five TW electrodes and six RF electrodes and FIGS. 2B-2F show examples with arrays of six TW electrodes and five RF electrodes, other suitable numbers and/or ratios of TW and RF electrodes can be used (e.g., 5:4, 4:3, 3:2). In some aspects, changing the ratio of TW to RF electrodes requires a change in the TW electrode length (because of the turns). In some aspects, the spacing between all electrodes is kept the same at 0.15 mm. In some examples, other spacings may be used, e.g., smaller than 0.05 mm, 0.05 mm, 0.1 mm, 0.2 mm, larger than 0.2 mm, etc.

In some aspects, and as illustrated in FIG. 2D, the number of TW electrodes can be increased as compared to the configurations of FIGS. 2A-2C to fill the space provided by the reduced length of the TW electrodes. As shown, the example electrode arrangement in FIG. 2C uses 16 TW electrodes in the straight paths, and FIG. 2D uses 24 TW electrodes based on the shorter TW electrode length. In some aspects, the increase in the number of TW electrodes does not necessarily correspond to an increased path length.

FIG. 2E illustrates another example of an IM device 222, showing the substantial space savings that can be achieved by removing outer guard electrodes and reducing the width of the inner guard electrodes (by replacement with a new RF electrode 207). As shown, the electrodes of the IM device 222 are aligned to an upper left position of the empty space 218 associated with IM device 220. Because there is a large amount of white space 223 on the right side of FIG. 2E, another U-turn and straight track can be added in place of the white space 223 in some aspects, e.g., as shown in example IM device 224 of FIG. 2F. Comparing FIG. 2A and FIG. 2F, it can be seen that three ion pathways can be made to fit into approximately the same space that could fit only two ion pathways using 3 mm width guard electrodes. In many examples, the electrodes extend slightly over the bottom area whereas the array of FIG. 2A did not extend past this area. However, a small amount of white space 225 can remain, shown on the right side of FIG. 2F. Thus, in many examples, the amount of extra space required by the addition of a new ion pathway and the amount of extra space available on the right side of FIG. 2E are similar (as shown in FIG. 2F the white space actually appears even larger than the extra space required by the extra ion pathway). As a result, in some aspects, a longer ion pathway can be fit into the same space without changing the size of the instrument.

### VI. Traveling Waves

### A. Traveling Waves, in General

In some aspects, and as introduced above, additional electronic reconfiguration can be used to enable IM separation without the DC guard electrodes. For example, as mentioned previously, shrinking or removing the guard electrode can, in some aspects, allow ions to hop from one ion pathway to an adjacent ion pathway, often where the ion pathway turns, which is not desirable. To keep ions confined to the ion pathway, outer TW electrodes are decoupled from inner TW electrodes in some aspects, such that different traveling waves can be applied to the outer TW electrodes.

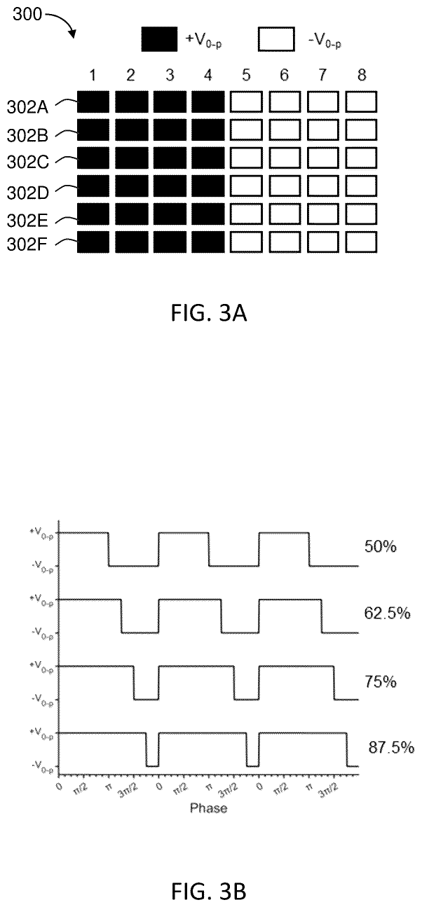

In a “traveling wall” IM system, the same traveling waves are applied to all the TW electrodes in an array. To illustrate such a system, a depiction of an array 300 of six TW electrodes is shown in FIG. 3A. RF electrodes that can be interspersed are omitted for clarity purposes, but it will be appreciated that various arrangements of RF electrodes can be included. The six TW electrodes forming the array 300 are illustrated in the vertical direction. To form a traveling wave, in some aspects, eight TW electrodes (labeled 1-8) are placed one after the other in six tracks 302A-302F, and then phase-shifted waveforms are applied to them. The phase-shifted waveforms applied to the tracks of TW electrodes 302A-302F can have any suitable periodic profile. Some examples of suitable waveforms include, but are not limited to, square waves, sine waves, equilateral triangles, right triangles, and any combination or combinations thereof. If a square waveform is chosen (as an example), in some aspects, square waves that are phase shifted by 45° (or π/4) can be applied to each track of TW electrodes 302A-302F. In FIG. 3A, the TW electrodes are colored either black or white to indicate the phase of the waveform. In some aspects, at any given time, four of the electrodes out of the eight in each track will possess a +V₀₋ₚ voltage, and four will possess a −V₀₋ₚ voltage.

It will be appreciated that any suitable number of tracks can be used to form traveling waves, with any suitable number of TW electrodes per track. For example, three or more tracks with two or more TW electrodes per track may be suitable to form a “traveling cup” waveform profile, which is described in more detail below. It is possible to use more than eight or fewer than eight TW electrodes per track. Suitable duty cycles and phase shifts can be determined based on the number of TW electrodes per track. For example, if 10 TW electrodes are used in each track, the duty cycles will be incremented in units of 10% (rather than 12.5% for a track of eight TW electrodes). In some aspects the duty cycle increment is equal to 360/n, where n is the number of TW electrodes in a track.

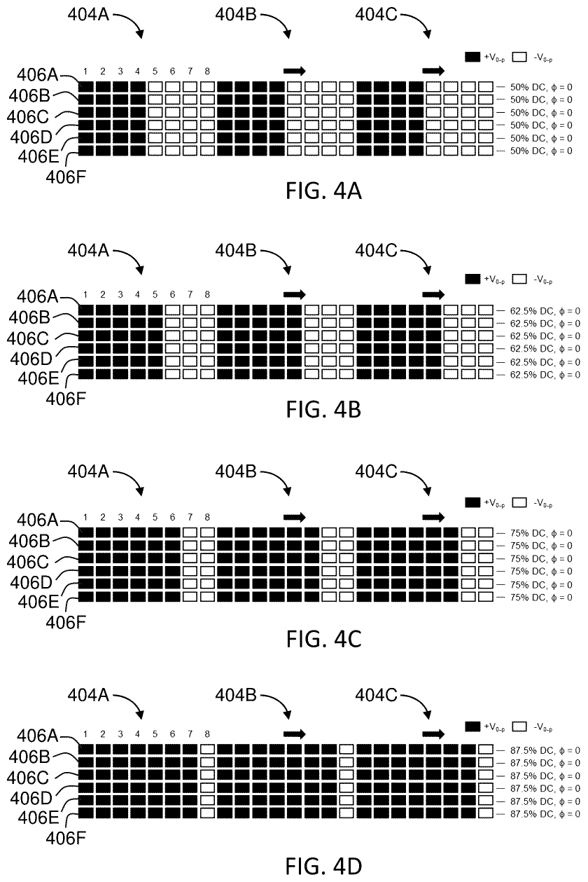

In some aspects, it is possible to change the number of TW electrodes that possess +V₀₋ₚ or −V₀₋ₚ at any given time by replacing the square wave with a rectangular wave and changing the duty cycle (a square wave is a rectangular wave with 50% duty cycle). A diagram of rectangular waves possessing 50%, 62.5%, 75%, and 87.5% duty cycles is given in FIG. 3B. FIGS. 4A-4D show examples of TW profiles in which the same rectangular waves are applied to three sets 404A-404C of eight TW electrodes arranged in six tracks 406A-406F. Note that FIGS. 4A-4D show twenty-four sets of TW arrays instead of eight allowing the leading and lagging edges of the traveling waves to be more clearly observed. As can be seen in FIGS. 4A-4D, all of the TW electrodes in an array possess the same phase and voltage (i.e., all electrodes in the vertical dimension are all either black or white) regardless of duty cycle. As discussed further herein, examples can include one or more arrays without the same phase and voltage.

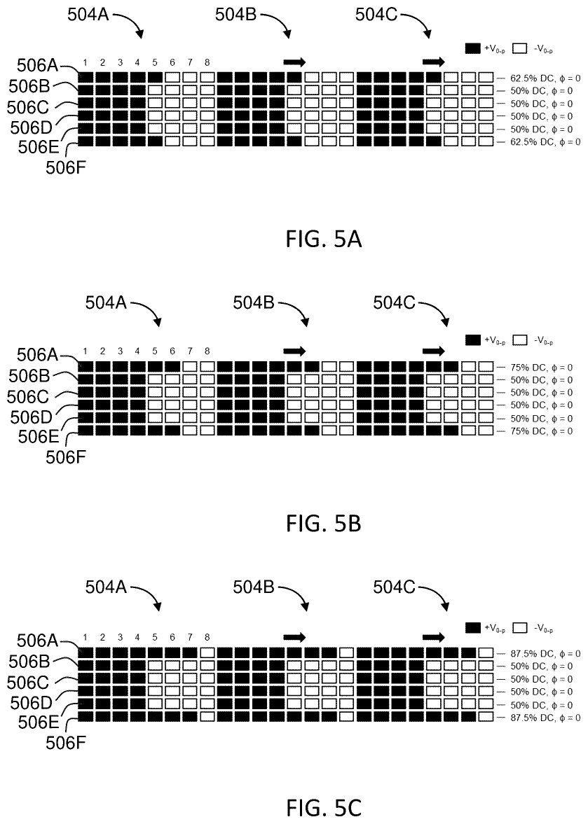

In many disclosed examples, traveling wave waveforms applied to outer tracks are different from traveling wave waveforms applied to inner TW tracks. This can be particularly advantageous with examples having reduced guard electrode width, such as examples described herein in which the ion pathway length may be increased for a common (or approximately common) footprint through the reduction in guard electrode width. In some aspects, the different waveforms can have different (1) amplitudes, (2) frequencies, (3) phases, (4) shapes, (5) duty cycles, or any combination or combinations thereof. In some examples with six TW electrode tracks, square waves (50% duty cycle rectangular waves) can be applied to the four innermost TW electrode tracks in the array and rectangular waves can be applied to the two outermost TW electrode tracks. Examples of applying square waves to four innermost TW electrode tracks 506B-506E and applying rectangular waves with 62.5%, 75%, and 82.5% duty cycles to two outermost TW electrode tracks 506A and 506F are shown in FIGS. 5A-5C. In some aspects, when 62.5% duty cycle rectangular waves are applied to the topmost TW electrode track 506A and bottommost TW electrode track 506F, the topmost and bottommost TW electrode tracks have one more TW electrode that possesses +V₀₋ₚ at a given moment in time than the innermost TW electrode tracks 506B-506E. In some aspects, this traveling wave profile exhibits a ‘cup-like’ geometry (i.e., high sides, low middle), rather than the ‘traveling wall’ geometry used in SLIM separations. This new traveling wave profile can be referred to herein as ‘traveling cups’ or a ‘traveling cup’ profile.

In some aspects, traveling cup profiles can be made ‘deeper’ by having a larger difference in duty cycle between the outer and inner tracks, e.g., by applying rectangular waves with higher duty cycles to the outermost TW electrode tracks 506A and 506F. For example, in some aspects, using rectangular waves with 75% duty cycles creates a cup that has two more TW electrodes that possess +V₀₋ₚ in each of the outermost TW electrode tracks 506A and 506F than the innermost TW electrode tracks 506B-506E. This can effectively create a deeper cup than when rectangular waves with 62.5% duty cycles are used.

In an example, the traveling cups can be made deeper by further increasing the duty cycle of the rectangular waves applied to the outermost TW electrode tracks 506A and 506F to 87.5%, which creates a cup that has three more TW electrodes in each of the outermost TW electrode tracks 506A and 506F that possess +V₀₋ₚ than the innermost TW electrode tracks 506B-506E. In some aspects, traveling cups can replace 3 mm guard electrodes used in SLIM devices and can laterally confine ions to the ion pathway. The traveling cup profile can have any suitable shape. Additional examples of suitable shapes are described in more detail below.

### B. Forward-Facing Traveling Cups

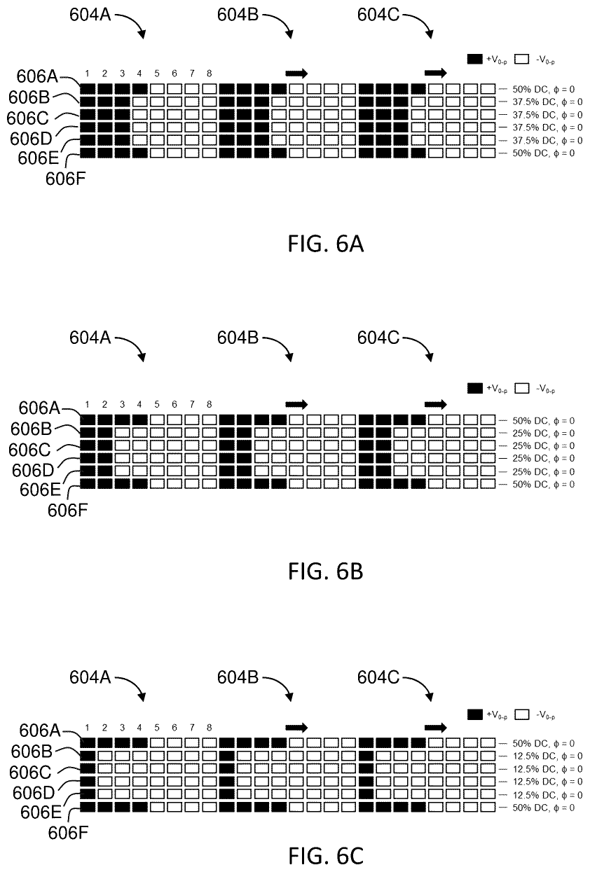

In some aspects, rectangular waveforms with less than 50% duty cycles can be applied to innermost TW electrode tracks 606B-606E while 50% duty cycle rectangular waveforms are applied to outermost TW electrode tracks 606A and 606F. A depiction of three different aspects is shown in FIG. 6A-6C. In some aspects, the duty cycle applied to the outermost TW electrode tracks 606A and 606F is 50% while the duty cycles applied to the innermost TW electrode tracks 606B-606E are 37.5%, 25%, and 12.5%. Applying waveforms with lower duty cycles to the innermost TW electrodes creates traveling cups with different depth. However, in some aspects, there are four electrodes out of the eight TW electrodes in each of the outermost TW electrode tracks 606A and 606F that possess −V₀₋ₚ voltages (white blocks). This can be an area where ions could escape or jump to an adjacent ion pathway if suitable lateral ion confinement is not provided by the waveforms applied to the outermost TW electrode tracks 606A and 606F.

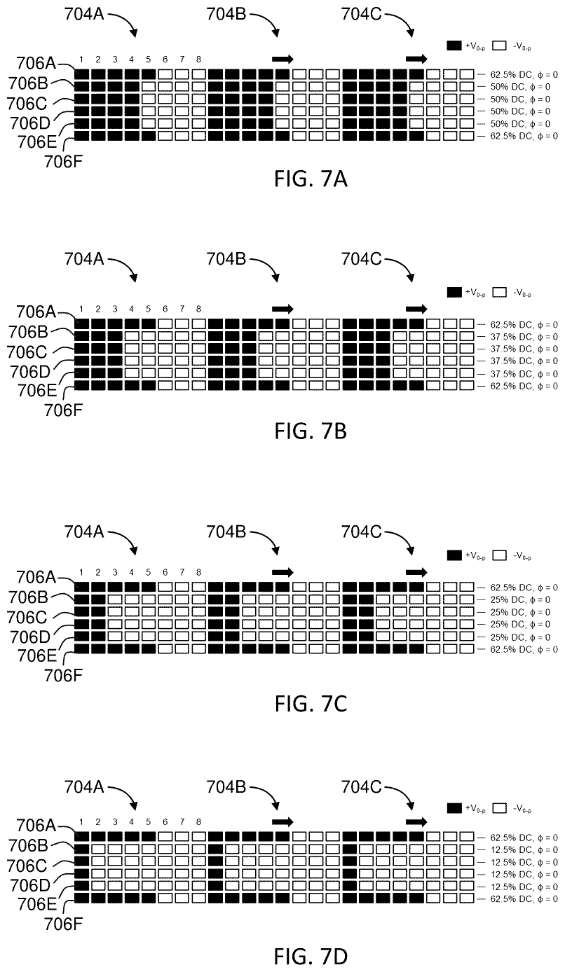

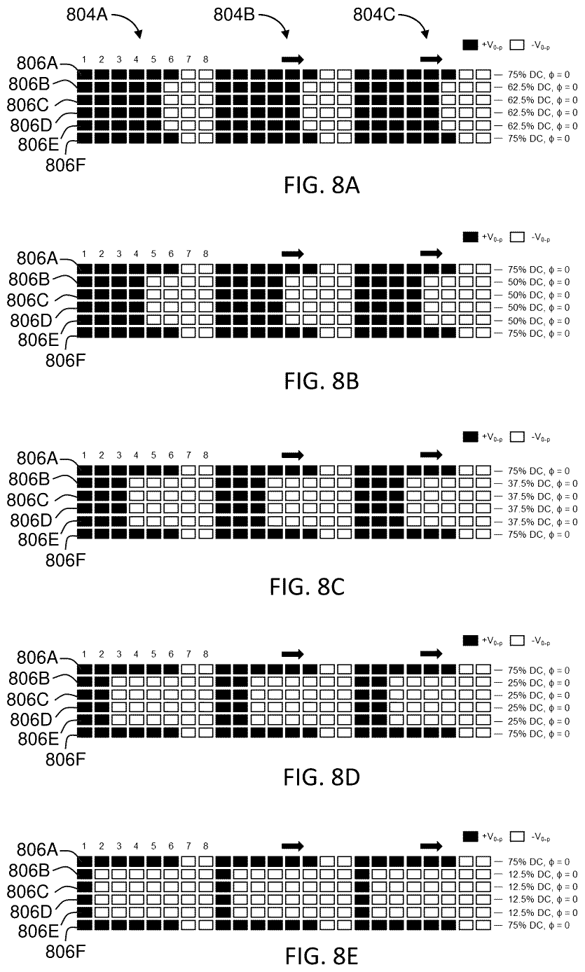

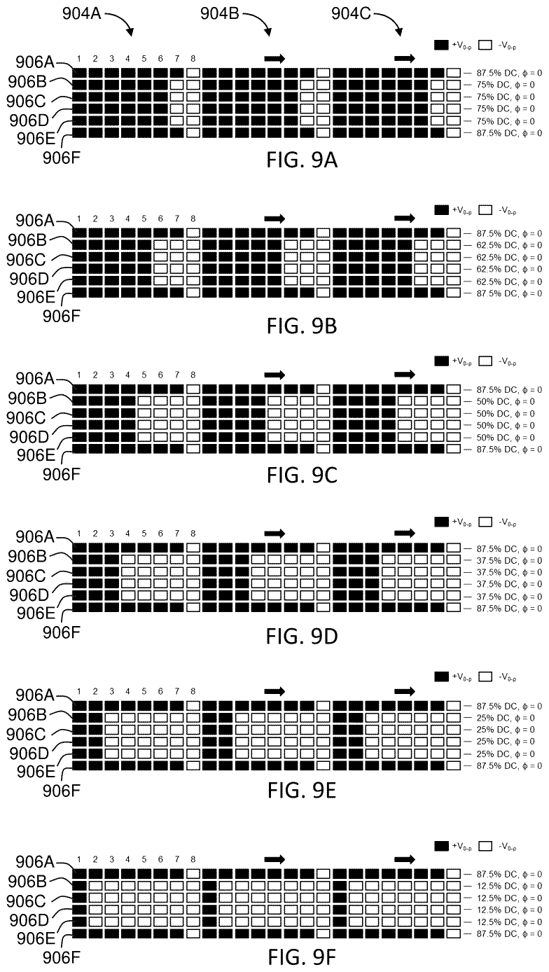

One way to reduce the possibility of ions jumping to adjacent pathways is to apply waveforms with higher duty cycles to the outermost TW electrode tracks 606A and 606F while applying waveforms with lower duty cycles to the innermost TW electrode tracks 606B-606E. This is can be achieved with the duty cycles of the waveforms applied to the TW electrodes of the outermost tracks 606A and 606F are 62.5%, 75%, and 87.5% while the duty cycles of the waveforms applied to the TW electrodes of the innermost tracks 606B-606E are varied between 12.5%, 25%, 37.5%, 50%, 62.5% (75% and 87.5% duty cycles on outermost TW electrodes only), and 75% (87.5% duty cycle on outermost TW electrodes only). The aspects using 62.5%, 75%, and 87.5% duty cycles on the TW electrodes of the outermost tracks and are shown in FIGS. 7A-7D, FIGS. 8A-8E, and FIGS. 9A-9F, respectively.

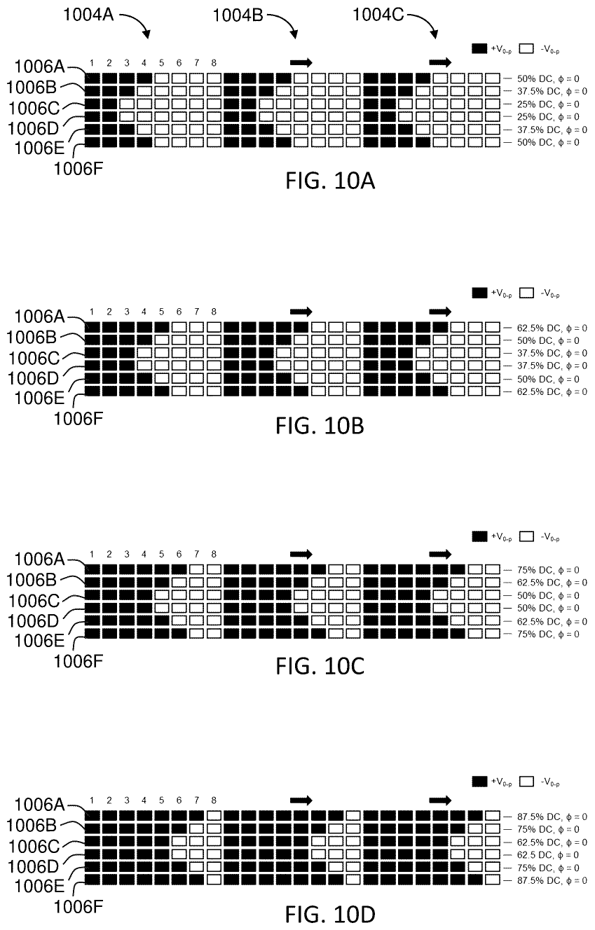

In some aspects, it is possible to apply different waveforms to each track, e.g., to each of six tracks of TW electrodes in an array. For example, in some aspects it is possible to apply one waveform to the two outermost TW electrode tracks, a second waveform to the two innermost TW electrode tracks, and a third waveform to the TW electrodes between the outermost and innermost TW electrode tracks. This allows for different cup shapes to be obtained. For example, and with reference now to FIG. 10A, in some aspects, a V-shaped cup can be obtained by applying a rectangular wave with a 50% duty cycle to two outermost TW electrode tracks 1006A and 1006F, a rectangular wave with a 37.5% duty cycle to two intermediate tracks 1006B and 1006E of TW electrodes, and a rectangular wave with a 25% duty cycle to two innermost TW electrode tracks 1006C and 1006D. This V-shape can be described using 50/37.5/25 nomenclature. The first value (i.e., 50%) denotes the duty cycle of the rectangular wave applied to the two outermost tracks 1006A and 1006F of the TW electrodes. The second value (i.e., 37.5%) denotes the duty cycle of the rectangular wave applied to the two intermediate tracks 1006B and 1006E of the TW electrodes. The third value (i.e., 25%) denotes the duty cycle of the rectangular wave applied to the two innermost tracks 1006C and 1006D of the TW electrodes. In some aspects, the V-shaped cup, like the previously described cups comprising a forward-facing opening, can be symmetric about the horizontal axis (i.e., symmetric about the direction of travel of the traveling wave). However, in some examples, traveling cups can be asymmetric.

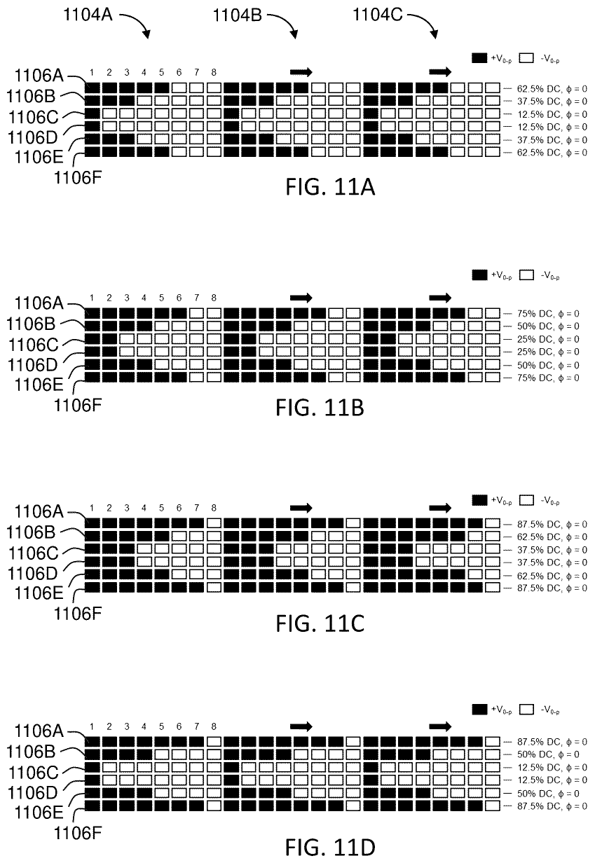

In some examples, other V-shaped cups can be used, e.g., by increasing and/or decreasing the duty cycles of the waveforms applied to different TW electrodes. Aspects of V-shaped cups with 62.5/50/37.5, 75/62.5/50, and 87.5/75/62.5 duty cycles are shown in FIG. 10A, FIG. 10B, and FIG. 10C, respectively. These figures show the V-shape being formed by incrementally decreasing the duty cycle of waveforms applied to the outermost, intermediate, and innermost TW electrode tracks by 12.5%. In some aspects, it is possible to use larger decrements (e.g., 25%) to form the V-shape, so long as the duty cycle applied to the two outermost tracks of TW electrodes is sufficiently large to provide suitable lateral confinement of ions. Aspects of V-shaped cups with 62.5/37.5/12.5, 75/50/25, and 87.5/62.5/37.5 duty cycles are shown in FIG. 11A, FIG. 11B, and FIG. 11C, respectively. In some aspects, it is also possible to use a decrement of 37.5% when the duty cycle applied to the two outermost TW electrode tracks is 87.5%. A depiction of a V-shaped cup using a 37.5% decrement is shown in FIG. 11D.

### C. Backward-Facing Traveling Cups

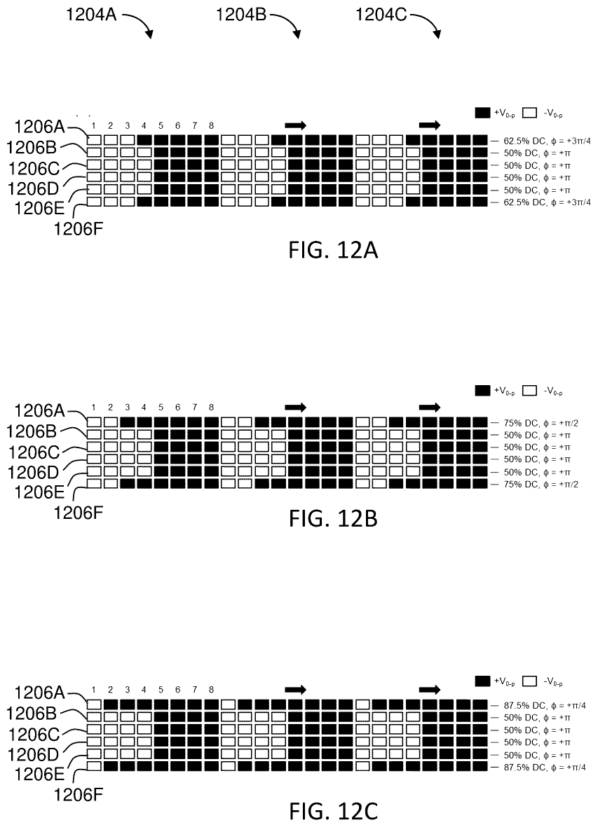

In some aspects, traveling cups have a backward (or opposite)-facing opening direction compared to a direction that the traveling wave is moving. Aspects of backward-facing traveling cups are shown in FIGS. 12A-12C.

Similar to the forward-facing cups, in some aspects, rectangular waveforms with 62.5% (FIGS. 12A), 75% (FIG. 12B), and 87.5% (FIG. 12C) duty cycles are applied to the outermost TW electrode tracks while rectangular waveforms with 50% duty cycles are applied to the innermost TW electrode tracks. In some aspects, the backward-facing cup possesses an opening facing the left side of the figure (rather than facing the right side of the figure). However, as denoted by the black arrows in FIGS. 12A-12C, the traveling waves move from left to right. In some aspects, the backward-facing cups also utilize waveforms with different phase shifts. The phase-shifts are reported in radians and are incremented in units of π/4 (in aspects where there are 8 TW electrodes per track). In some aspects, to determine the phase-shift, the rectangular waveform with a given duty cycle is first applied to the TW electrodes, and then the profile is advanced (to the right in the image) until the backward face is formed. As an example, the reverse-facing cup in FIG. 12A is formed by applying a 62.5% duty cycle rectangular waveform to outermost TW electrode tracks 1206A and 1206F and moving it to the right by three TW electrodes. Since the phase-shifts are in increments of π/4, moving the waveform by three TW electrodes means the phase shift is 3×π/4=+3π/4. Similarly, a 50% duty cycle rectangular waveform is applied to the innermost TW electrode tracks. Moving it to the right by four TW electrodes gives a phase shift of 4×π/4=+π. Note that the phase shifts reported herein may be described by comparison to the duty cycle given in FIG. 3B, hence the + sign.

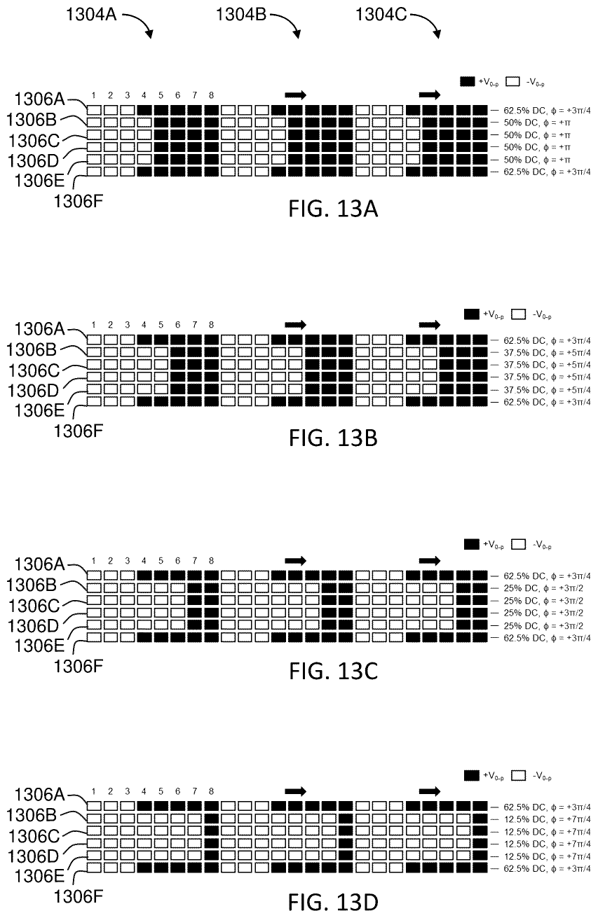

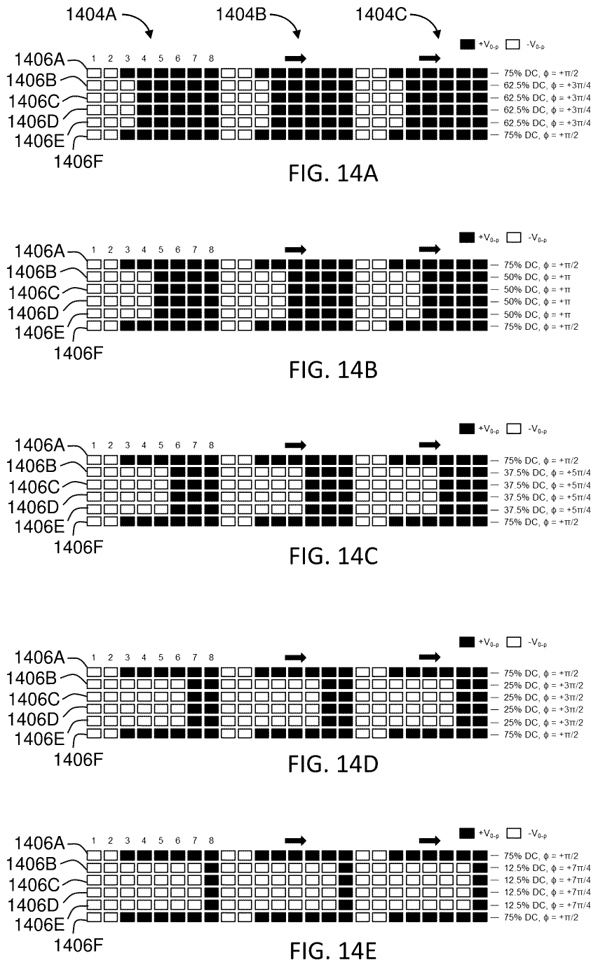

In some aspects, different shapes can be formed based on variations of the backward-facing traveling cups. In some aspects, the depth of the backward-facing cup can be adjusted by fixing the duty cycle and phase shift of the rectangular waveform applied to the outermost TW electrode tracks and varying the duty cycle and phase shift of the rectangular waveform applied to the innermost TW electrode tracks. Aspects of backward-facing traveling cups using a 62.5% duty cycle and +3π/4 phase-shifted rectangular waveform applied to the outermost TW electrode tracks and 50% (+π), 37.5% (+5π/4), 25% (+3π/2), and 12.5% (+7π/4) rectangular waveforms applied to the innermost TW electrode tracks are shown in FIG. 13A, FIG. 13B, FIG. 13C, and FIG. 13D, respectively. Aspects of backward-facing traveling cups using a 75% duty cycle and +π/2 phase-shifted rectangular waveform applied to the outermost TW electrode tracks and 62.5% (+3π/4), 50% (+π), 37.5% (+5π/4), 25% (+3π/2), and 12.5% (+7π/4) rectangular waveforms applied to the innermost TW electrode tracks are shown in FIG. 14A, FIG. 14B, FIG. 14C, FIG. 14D, and FIG. 14E, respectively.

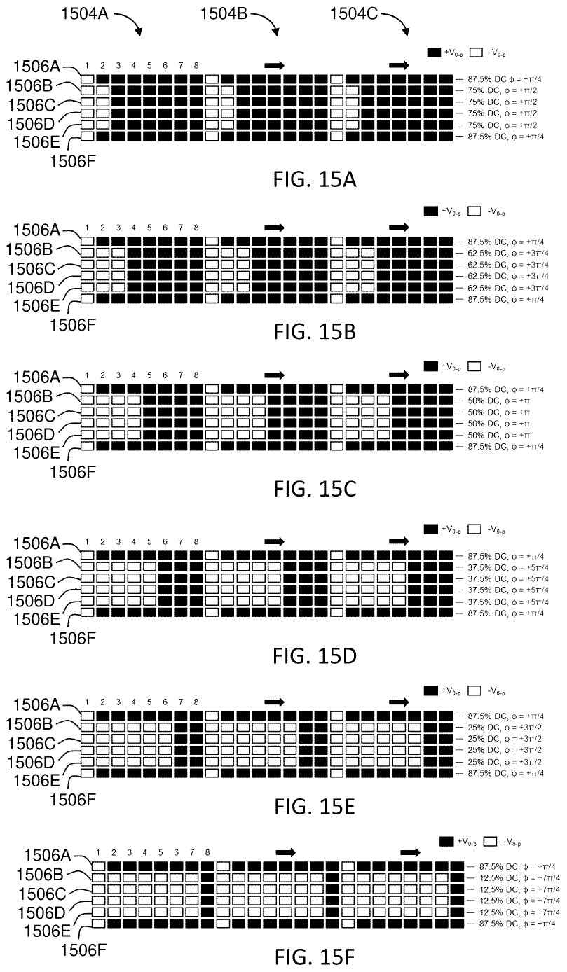

Lastly, aspects of backward-facing traveling cups using an 87.5% duty cycle and +π/4 phase-shifted rectangular waveform applied to the outermost TW electrode tracks and 75% (+π/2), 62.5% (+3π/4), 50% (+π), 37.5% (+5π/4), 25% (+3π/2), and 12.5% (+7π/4) rectangular waveforms applied to the innermost TW electrode tracks are shown in FIG. 15A, FIG. 15B, FIG. 15C, FIG. 15D, FIG. 15E, and FIG. 15F, respectively.

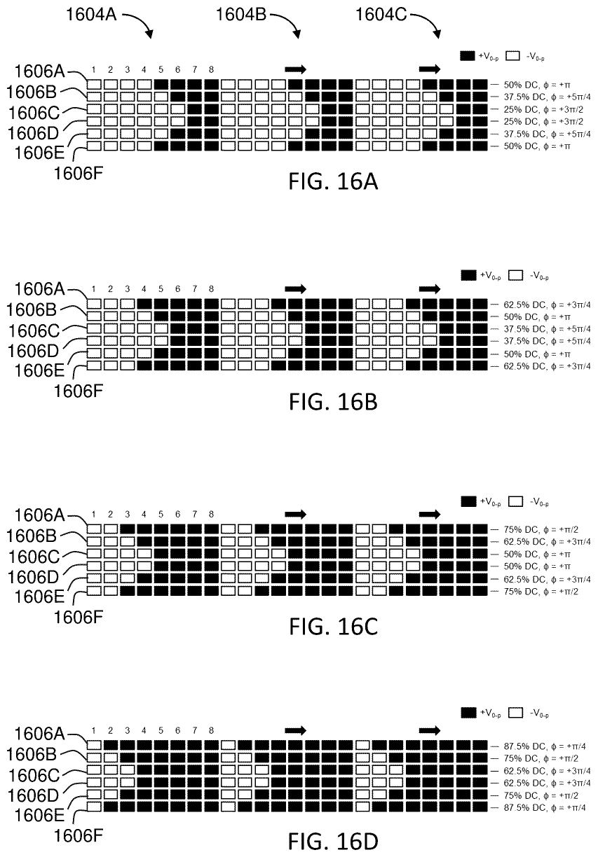

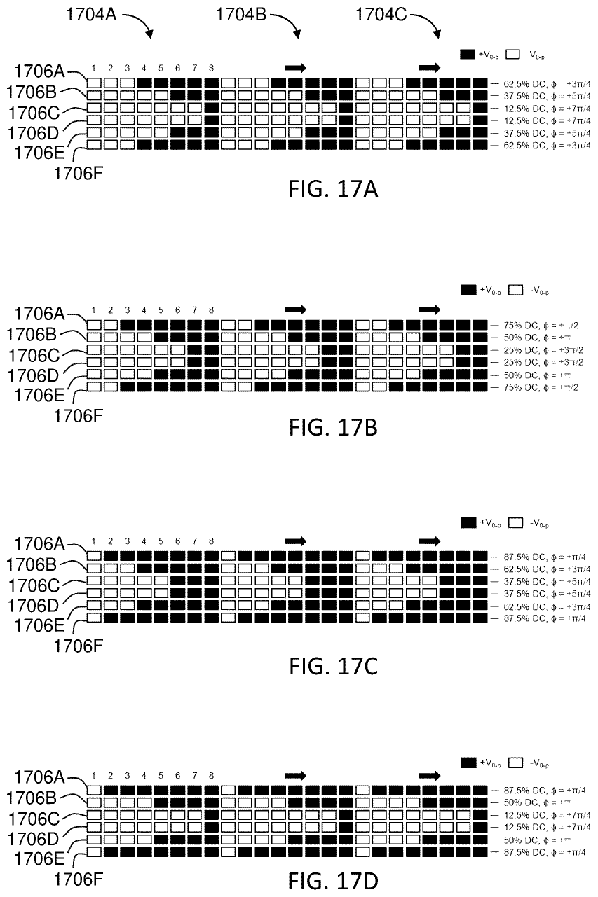

In some aspects, it is also possible to create backward-facing traveling cups that possess V shapes (instead of U shapes). Aspects of V-shaped cups with 50/37.5/25 (+π/+5π/4/+3π/2), 62.5/50/37.5 (+3π/4/+π/+5π/4), 75/62.5/50 (+π/2/+3π/4/+π), and 87.5/75/62.5 (+π/4/+π/2/+3π/4) are shown in FIG. 16A, FIG. 16B, FIG. 16C, and FIG. 16D, respectively. In some aspects, the depth of the backward-facing V-shaped traveling cups can also be increased by adjusting the duty cycles (and phase-shifts) of the rectangular waveforms applied to the outermost, intermediate, and innermost TW electrode tracks. Aspects of backward-facing V-shaped cups with duty cycle profiles of 62.5/37.5/12.5 (+3π/4/+5π/4/+7π/4), 75/50/25 (+3π/2/+π/+3π/2), and 87.5/62.5/37.5 (+π/4/+3π/4/+5π/4), are shown in FIG. 17A, FIG. 17B, and FIG. 17C, respectively. In some aspects, a deep backward-facing V-shaped traveling cup shown in FIG. 17D can be formed by applying a rectangular waveform with 87.5/50/12.5 (+π/4/+π/+7π/4) duty cycles and phase-shifts to the outermost, intermediate, and innermost TW electrode tracks.

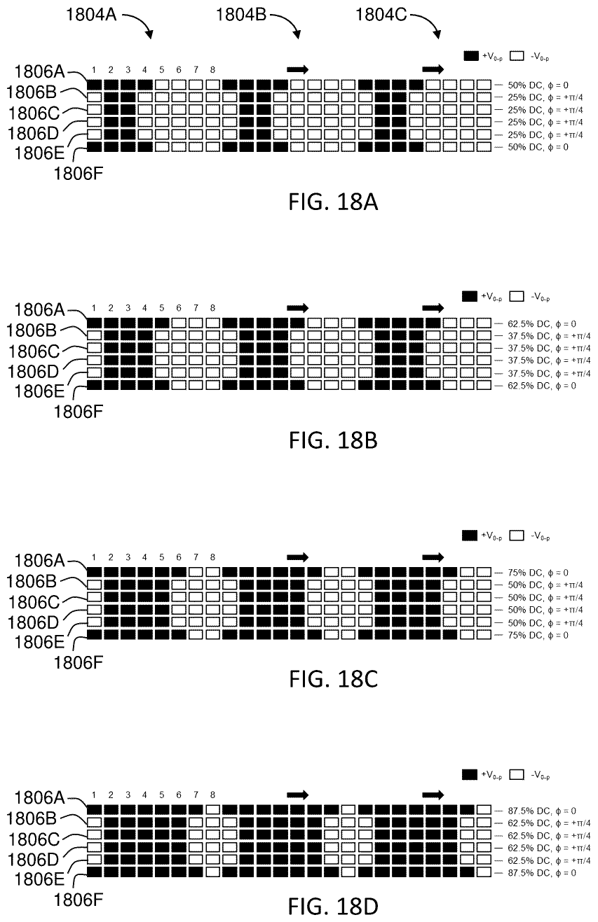

As described above, in some aspects, traveling cups possess openings facing either forwards or backwards relative to the direction of travel of the traveling wave. In some aspects, traveling cups have openings on both sides. Traveling cups with openings on both sides are described herein as “symmetric” traveling cups. Some examples of symmetric traveling cups are shown in FIGS. 18A-18D. Similar to the backward-facing traveling cups, the symmetric traveling cups are created by applying rectangular waveforms with different duty cycles and phase shifts to the outermost and innermost tracks of TW electrodes. However, in the symmetric profiles, the phase shifts of the rectangular waveforms are not as large as they are in the backward-facing traveling cups. For example, in some aspects, it is possible to form a symmetric traveling cup by applying a rectangular waveform with 50% duty cycle (+0 phase shift) to the outermost TW electrode tracks and a rectangular waveform with 25% duty cycle (+π/2 phase shift) to the innermost TW electrode tracks. FIG. 18A shows aspects of this waveform profile. In some aspects, the duty cycles of the rectangular waveforms applied to the outermost and innermost TW electrode tracks are increased to form other shapes.

Aspects of symmetric traveling cups formed using 62.5/37.5 (+0/+π/4), 75/50 (+0/+π/4), and 87.5/62.5 (+0/+π/4) are shown in FIG. 18B, FIG. 18C, and FIG. 18D, respectively, which are symmetric in two dimensions. The first symmetry is about the horizontal axis. However, the second symmetry is about the vertical axis when centered on the traveling cup (i.e., mirror images on the left and right).

### D. Symmetric Traveling Cups

Similar to the forward-facing and backward-facing traveling cups, there are many different shape profiles that can be formed with the symmetric traveling cups. For example, in some aspects, the depth of the cup can be increased by lowering the duty cycle of the rectangular waveform applied to the innermost TW electrode tracks (and applying corresponding phase shifts).

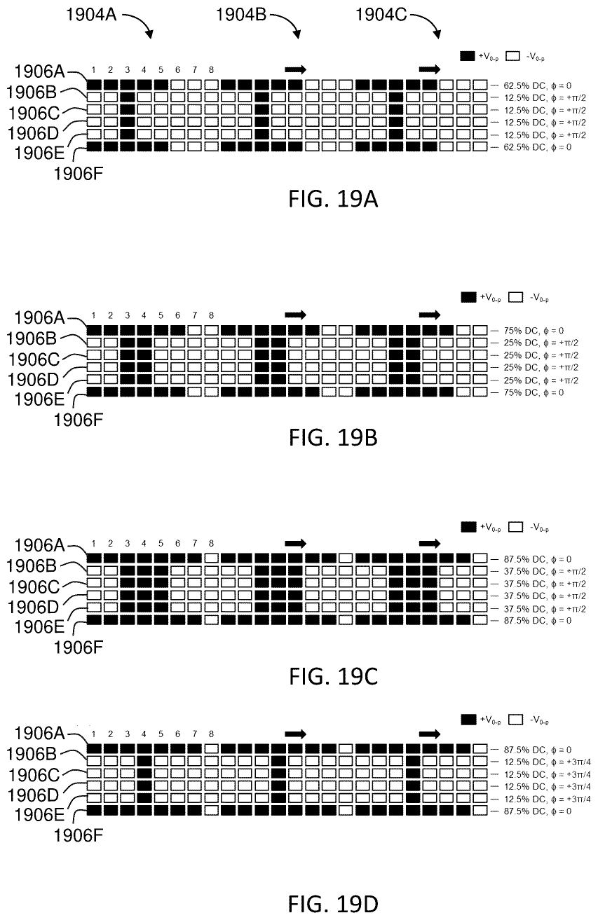

Aspects of deeper symmetric traveling cups formed using 62.5/12.5 (+0/+π/2), 75/25 (+0/+π/2), and 87.5/37.5 (+0/+π/2) duty cycle profiles are shown in FIG. 19A, FIG. 19B, and FIG. 19C, respectively. Additionally, in some aspects, a more deep symmetric cup can be formed by applying a rectangular waveform with 87.5/12.5 (+0/+3π/4) duty cycles and phase shifts to outermost and innermost TW electrode tracks 1906A and 1906F as shown in FIG. 19D.

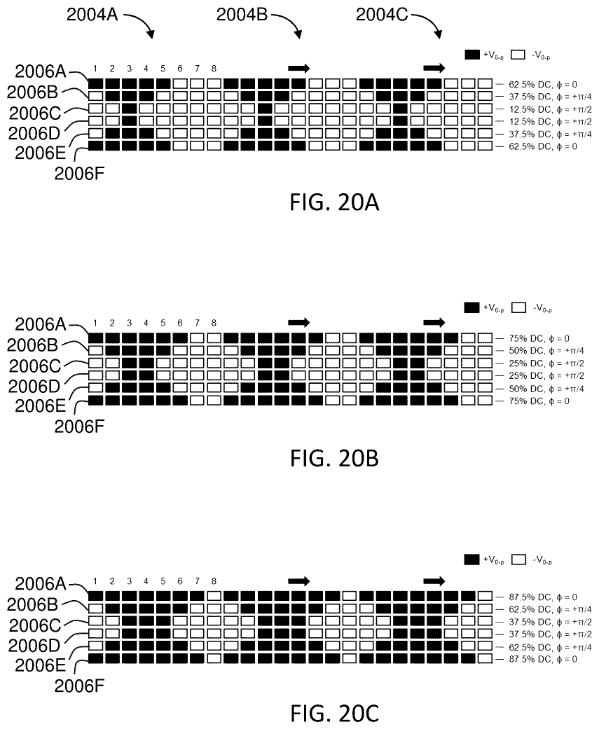

Similar to the aspects described above for the forward-facing and backward-facing traveling cups, it is also possible to form symmetric traveling cups that possess V shapes on both sides of the waveform in some aspects. Aspects of V-shaped symmetric traveling cups using rectangular waveforms with duty cycles (and phase shifts) of 62.5/37.5/12.5 (+0/+π/4/+π/2), 75/50/25 (+0/+π/4/+π/2), and 87.5/62.5/37.5 (+0/+π/4/+π/2) are shown in FIG. 20A, FIG. 20B, and FIG. 20C, respectively.

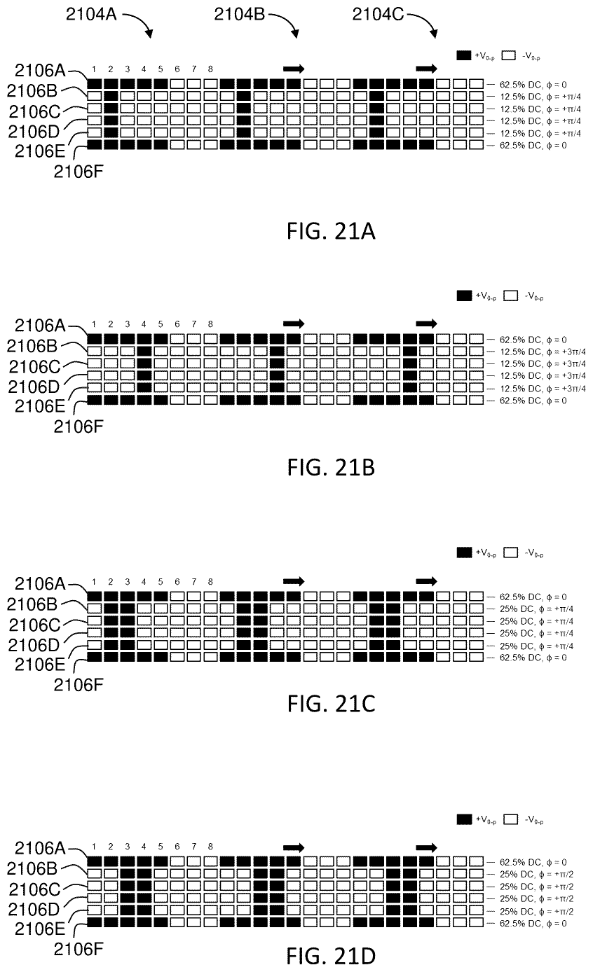

In some aspects, shapes generated based on the symmetric cup design (i.e., openings facing left and right) result in the loss of symmetry about the vertical dimension. These profiles can be referred to as “asymmetric” traveling cups. Some examples of asymmetric traveling cups are shown in FIGS. 21A-21D. FIGS. 21A-21D show a rectangular waveform with 62.5% duty cycle applied to outermost TW electrode tracks 2106A and 2106F. However, in some aspects, the rectangular waveform applied to the innermost TW electrode tracks 2106B-2106E can be varied in terms of its duty cycle and phase shift. In some aspects, the asymmetric traveling cup depicted in FIG. 21A is formed by applying a rectangular waveform with 12.5% duty cycle and +π/4 phase shift to the innermost TW electrode tracks 2106B-2106E. In some aspects, the asymmetric traveling cup depicted in FIG. 21B can be formed by keeping the duty cycle fixed at 12.5% but increasing the phase shift to +3π/4. In keeping with this logic, in some aspects, it is possible to form more asymmetric traveling cups by applying a rectangular waveform with a 25% duty cycle to the innermost TW electrode tracks 2106B-2106E and phase shifting the waveforms by +π/4 and +π/2. Aspects of these asymmetric traveling cup profiles are shown in FIG. 21C and FIG. 21D.

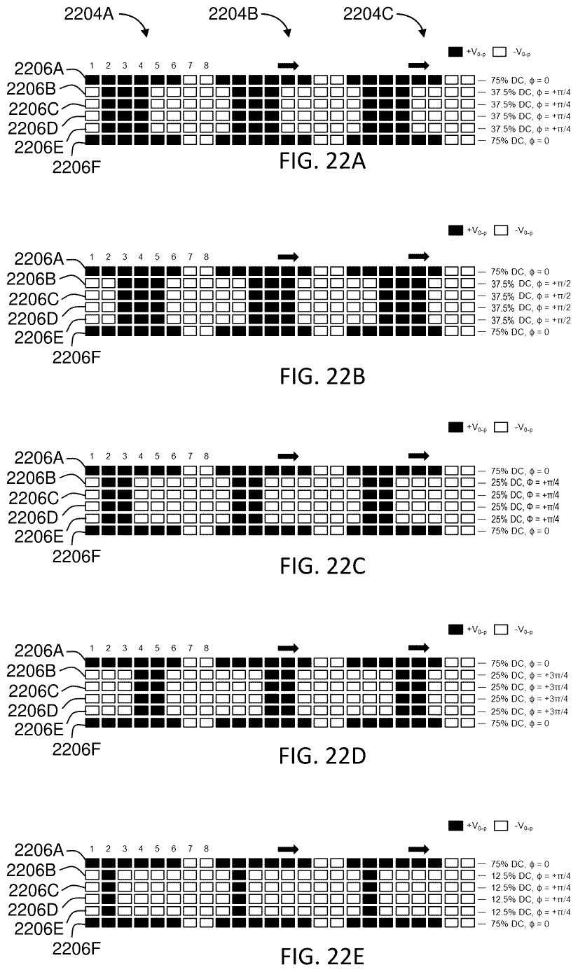

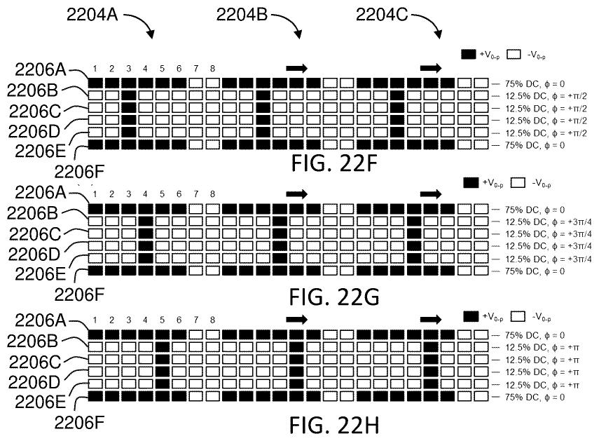

In some aspects, other shapes of asymmetric traveling cups can be formed by increasing the duty cycle of the rectangular wave applied to the outermost TW electrode tracks and varying the duty cycle and phase shift of the rectangular waveform applied to the innermost TW electrode tracks. Aspects of asymmetric traveling cups with a rectangular waveforms possessing 75% duty cycle (+0 phase shift) applied to outer TW electrode tracks 2206A and 2206F and 37.5% (+π/4), 37.5% (+π/2), 25% (+π/4), 25% (+3π/4), 12.5% (+π/4), 12.5% (+π/2), 12.5% (+3π/4), and 12.5% (+π) applied to the innermost TW electrode tracks 2206B-2206E are given in FIG. 22A, FIG. 22B, FIG. 22C, FIG. 22D, FIG. 22E, FIG. 22F, FIG. 22G, and FIG. 22H, respectively.

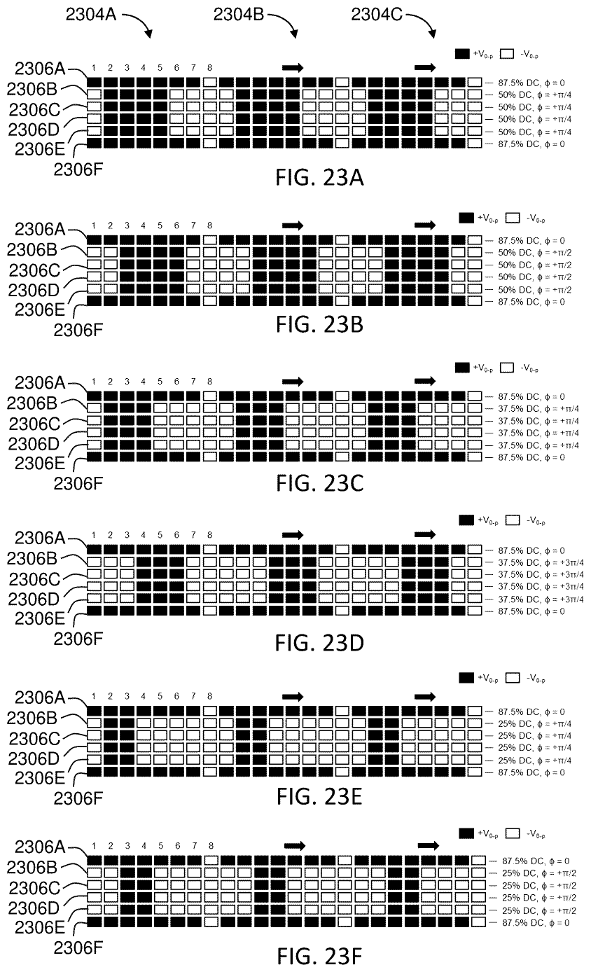

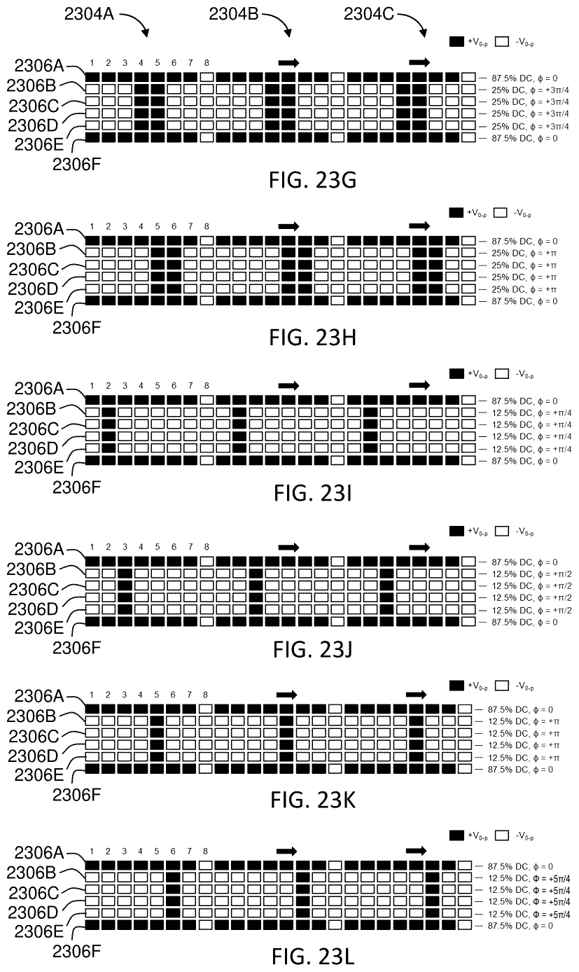

Lastly, aspects of asymmetric traveling cups with a rectangular waveform possessing an 87.5% duty cycle (+0 phase shift) applied to the outer TW electrode tracks and 50% (+π/4), 50% (+π/2), 37.5% (+π/4), 37.5% (+3π/4), 25% (+π/4), 25% (+π/2), 25% (+3π/4), 25% (+π), 12.5% (+π/4), 12.5% (+π/2), 12.5% (+π), and 12.5% (+3π/2) applied to the innermost TW electrode tracks are given in FIG. 23A, FIG. 23B, FIG. 23C, FIG. 23D, FIG. 23E, FIG. 23F, FIG. 23G, FIG. 23H, FIG. 23I, FIG. 23J, FIG. 23K, and FIG. 23L, respectively.

### E. Other Shapes

The aspects of traveling waves described above can span the range of rectangular waveforms possessing 50% duty cycles to 87.5% duty cycles applied to the outermost TW electrode tracks. However, in some aspects, rectangular waveforms can be applied with less than 50% duty cycles to the outer TW electrode tracks and change the duty cycle of the rectangular waveforms applied to the innermost TW electrode tracks in a manner similar to previously described.

In various examples, a quantity of electrode tracks different from six TW electrode tracks may be used. It is possible to use more or less than six TW electrode tracks in some aspects, while generating traveling cup profiles by applying any suitable waveform with any suitable duty cycle and phase shift as described above. Any suitable waveform can be used. Some examples of suitable waveforms include, but are not limited to, rectangular waveforms, sinusoidal waveforms and triangular waveforms.

### VII. Methods

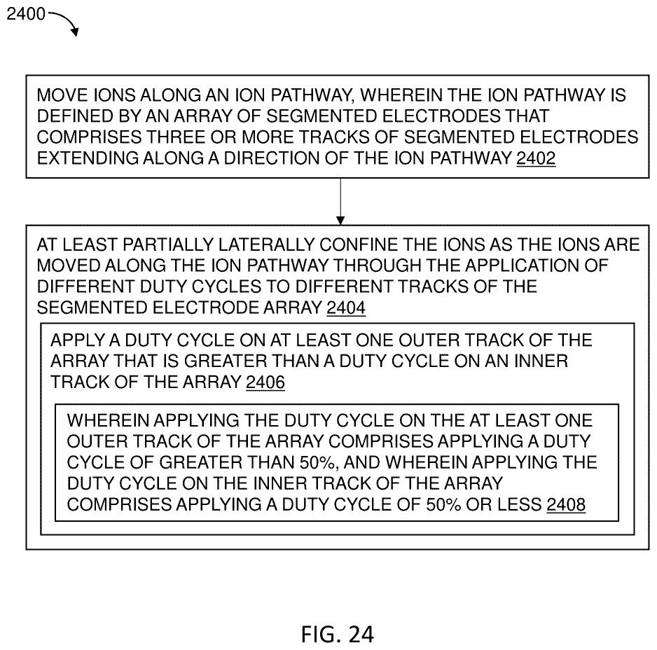

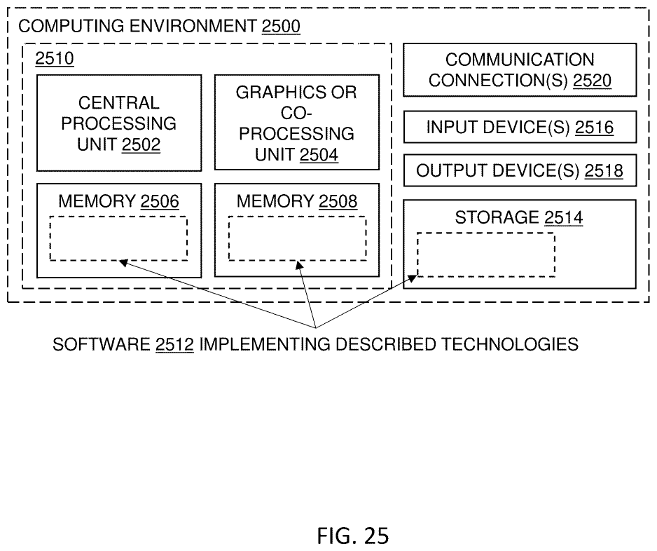

FIG. 24 shows a flow diagram depicting aspects of an example method 2400 for moving ions along an ion pathway. The following description of the method 2400 is provided with reference to FIGS. 1-23 above and FIGS. 25-34 below. It will be appreciated that the method 2400 also can be performed in other contexts.

At 2402, the method 2400 comprises moving ions along an ion pathway, wherein the ion pathway is defined by an array of segmented electrodes that comprises three or more tracks of segmented electrodes extending along a direction of the ion pathway.

The method 2400 further comprises, at 2404, at least partially laterally confining the ions as the ions are moved along the ion pathway through the application of different duty cycles to different tracks of the segmented electrode array.

In some aspects, at 2406, at least partially laterally confining the ions comprises applying a duty cycle on at least one outer track of the array that is greater than a duty cycle on an inner track of the array.

At 2408, in some aspects, applying the duty cycle on the at least one outer track of the array comprises applying a duty cycle of greater than 50%, and wherein applying the duty cycle on the inner track of the array comprises applying a duty cycle of 50% or less.

### VIII. Computing System

FIG. 25 depicts a generalized example of a suitable computing system 2500 in which the described innovations may be implemented. The computing system 2500 is not intended to suggest any limitation as to scope of use or functionality of the present disclosure, as the innovations may be implemented in diverse general-purpose or special-purpose computing systems.

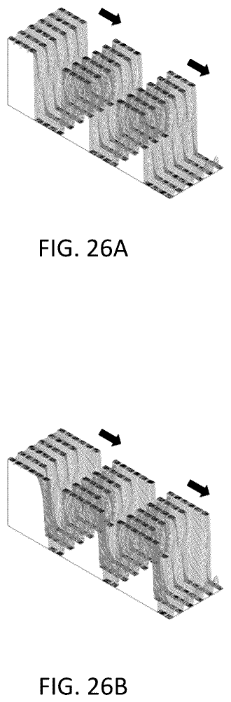

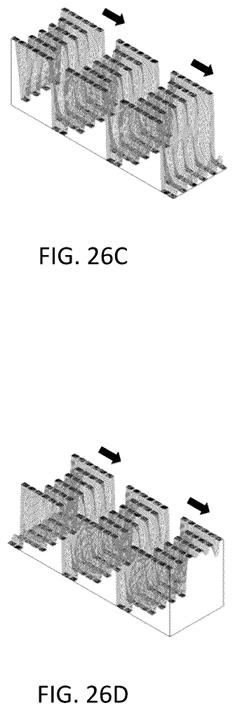

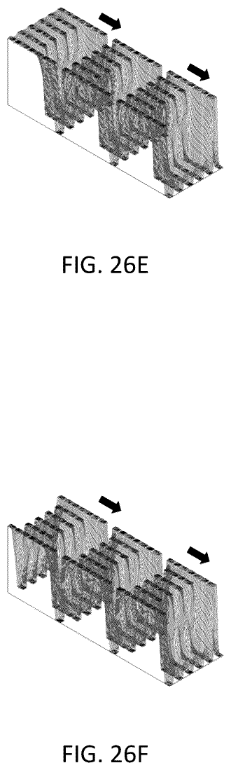

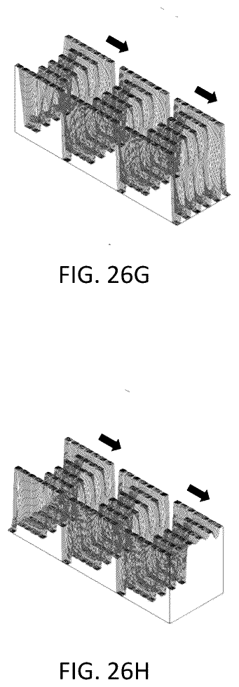

With reference to FIG. 25, the computing system 2500 includes one or more processing units 2502, 2504 and memory 2506, 2508. In FIG. 25, this basic configuration 2510 is included within a dashed line. The processing units 2502, 2504 execute computer-executable instructions, such as for implementing components of the computing environments of, or providing the outputs (e.g., traveling waves) shown in, FIGS. 1-24, described above, and FIGS. 26-34 described below. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 25 shows a central processing unit 2502 as well as a graphics processing unit or co-processing unit 2504. The tangible memory 2506, 2508 may be volatile memory (e.g., registers, cache, RAM), non-volatile memory (e.g., ROM, EEPROM, flash memory, etc.), or some combination of the two, accessible by the processing unit(s) 2502, 2504. The memory 2506, 2508 stores software 2512 implementing one or more innovations described herein, in the form of computer-executable instructions suitable for execution by the processing unit(s) 2502, 2504.

The computing system 2500 may have additional features. For example, the computing system 2500 includes tangible storage 2514, one or more input devices 2516, one or more output devices 2518, and one or more communication connections 2520. An interconnection mechanism (not shown) such as a bus, controller, or network interconnects the components of the computing system 2500. Typically, operating system software (not shown) provides an operating environment for other software executing in the computing system 2500, and coordinates activities of the components of the computing system 2500.

The tangible storage 2514 may be removable or non-removable, and includes magnetic disks, magnetic tapes or cassettes, CD-ROMs, DVDs, or any other medium which can be used to store information in a non-transitory way and which can be accessed within the computing system 2500. The tangible storage 2514 stores instructions for the software 2512 implementing one or more innovations described herein.

The input device(s) 2516 may be a touch input device such as a keyboard, mouse, pen, or trackball, a voice input device, a scanning device, or another device that provides input to the computing system 2500. The output device(s) 2518 may be a display, printer, speaker, CD-writer, or another device that provides output from the computing system 2500.

The communication connection(s) 2520 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system. In general, a computing system or computing device can be local or distributed, and can include any combination of special-purpose hardware and/or general-purpose hardware with software implementing the functionality described herein. In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general-purpose program, such as one or more lines of code in a larger or general-purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Described algorithms may be, for example, embodied as software or firmware instructions carried out by a digital computer. For instance, any of the disclosed few-shot machine learning, automation, and montaging techniques can be performed by one or more a computers or other computing hardware that is part of a data acquisition system. The computers can be computer systems comprising one or more processors (processing devices) and tangible, non-transitory computer-readable media (e.g., one or more optical media discs, volatile memory devices (such as DRAM or SRAM), or nonvolatile memory or storage devices (such as hard drives, NVRAM, and solid state drives (e.g., Flash drives)). The one or more processors can execute computer-executable instructions stored on one or more of the tangible, non-transitory computer-readable media, and thereby perform any of the disclosed techniques. For instance, software for performing any of the disclosed embodiments can be stored on the one or more volatile, non-transitory computer-readable media as computer-executable instructions, which when executed by the one or more processors, cause the one or more processors to perform any of the disclosed techniques or subsets of techniques. The results of the computations can be stored in the one or more tangible, non-transitory computer-readable storage media and/or can also be output to the user, for example, by displaying, on a display device, image segmentations with a graphical user interface.

### IX. Overview of Several Embodiments

Disclosed herein are aspects of an ion mobility device, comprising: an ion pathway; a plurality of segmented electrodes arranged in an array that comprises three or more tracks of segmented electrodes, wherein the plurality of segmented electrodes is configured to receive time-varying DC voltages to move ions along the ion pathway; and a controller configured to: charge the plurality of segmented electrodes with a waveform on at least one outer track of the array that is different from a waveform on an inner track of the array to provide at least some lateral confinement of the ions as the ions are moved along the ion pathway.

In any or all of the above aspects, the waveform on the at least one outer track of the array has a duty cycle that is different from the waveform on the inner track of the array.

In any or all of the above aspects, the duty cycle on the at least one outer track of the array is greater than the duty cycle on the inner track of the array.

In any or all of the above aspects, the controller is further configured to apply an intermediate duty cycle to an intermediate track located between the at least one outer track of the array and the inner track of the array.

In any or all of the above aspects, the plurality of segmented electrodes are charged with waveforms having different phase shifts, and the phase shifts are incremented in units of π/4.

In any or all of the above aspects, the controller is configured to form traveling wave sets that extend to move ions along the ion pathway.

In any or all of the above aspects, the ion mobility device further comprises a plurality of guard electrodes positioned laterally relative to the segmented electrodes, wherein the plurality of guard electrodes is configured to provide additional lateral confinement of the ions to the ion pathway.

In any or all of the above aspects, the ion mobility device further comprises a plurality of radiofrequency (RF) electrodes configured to confine ions to the ion pathway, wherein the controller is configured to apply RF power to the plurality of RF electrodes to prevent ions from approaching the RF electrodes and thereby provide additional lateral confinement of the ions to the ion pathway.

In any or all of the above aspects, the ion pathway comprises adjacent first and second legs and a connecting bend.

In any or all of the above aspects, the first and second legs are separated laterally by a distance that is less than half a width of the first and/or second leg.

Also disclosed herein are aspects of an ion mobility device, comprising: an electrode arrangement including adjacent first and second legs and a connecting bend that define an ion pathway, wherein the electrode arrangement includes traveling wave sets that extend to move ions along the ion pathway; wherein the first and second legs are separated laterally by a distance that is less than half a width of the first and/or second leg.

In any or all of the above aspects, the electrode arrangement comprises a plurality of segmented electrodes arranged in an array that comprises three or more tracks of segmented electrodes, wherein the traveling wave sets comprise a duty cycle on at least one outer track of the array that is different from a duty cycle on an inner track of the array to provide at least some lateral confinement of the ions as the ions are moved along the ion pathway.

In any or all of the above aspects, the duty cycle on the at least one outer track of the array is greater than the duty cycle on the inner track of the array.

In any or all of the above aspects, the duty cycle on the inner track of the array comprises a duty cycle of 50% or less, and the duty cycle on the at least one outer track of the array comprises a duty cycle of greater than 50%.

In any or all of the above aspects, the plurality of segmented electrodes are charged with waveforms having different phase shifts, wherein the phase shifts are incremented in units of π/4.

In any or all of the above aspects, the ion mobility device further comprises a plurality of guard electrodes positioned laterally relative to the ion pathway, wherein the plurality of guard electrodes is configured to provide additional lateral confinement of the ions to the ion pathway.

In any or all of the above aspects, the first and second legs are separated laterally by a distance that is less than half a width of the first and/or second leg.

Also disclosed herein are aspects of a method comprising: moving ions along an ion pathway, wherein the ion pathway is defined by an array of segmented electrodes that comprises three or more tracks of segmented electrodes extending along a direction of the ion pathway; and at least partially laterally confining the ions as the ions are moved along the ion pathway through the application of different duty cycles to different tracks of the segmented electrode array.

In any or all of the above aspects, at least partially laterally confining the ions comprises applying a duty cycle on at least one outer track of the array that is greater than a duty cycle on an inner track of the array.

In any or all of the above aspects, applying the duty cycle on the at least one outer track of the array comprises applying a duty cycle of greater than 50%, and wherein applying the duty cycle on the inner track of the array comprises applying a duty cycle of 50% or less.

### EXAMPLES

Aspects of the present teachings can be further understood in light of the following examples.

### A. Traveling Wall Slim Layout

As introduced above, the number of tracks of RF and TW electrodes in an array was switched from 6RF×5TW to 6TW×5RF. The reason for doing this was to demonstrate that applying longer duty cycles to the outermost TW electrode tracks confines ions to the tracks while keeping the size of the ion pathway the same. To evaluate whether applying rectangular waveforms with higher duty cycles to the outermost TW electrode tracks compared to the innermost TW electrode tracks, ion trajectory simulations were performed using SIMION. Potential energy surfaces demonstrate that rectangular waves with different duty cycles (and phase shifts) can be input into SIMION successfully. A snapshot of the potential energy surface generated in SIMION using 50% duty cycle rectangular waves applied to the outermost AND innermost TW electrode tracks is shown in FIG. 26A. This is a waveform profile commonly used in SLIM. Next, snapshots were obtained of the potential energy surfaces corresponding to the forward-facing, symmetric, and backward-facing aspects of the traveling cups formed when 75% and 87.5% duty cycle rectangular waves are applied to the outermost TW electrode tracks and 50% duty cycle rectangular waves are applied to the innermost TW electrode tracks. The potential energy surfaces obtained when using 75% duty cycle rectangular waveforms applied to the outer TW electrode tracks are given in FIG. 26B (forward-facing cup), FIG. 26C (symmetric cup), and FIG. 23D (backward-facing cup). Additionally, the potential energy surfaces obtained when using 87.5% duty cycle rectangular waveforms applied to the outer TW electrodes are given in FIG. 26E (forward-facing cup), FIG. 26F (asymmetric cup), FIG. 26G (asymmetric cup), and FIG. 26H (backward-facing cup).

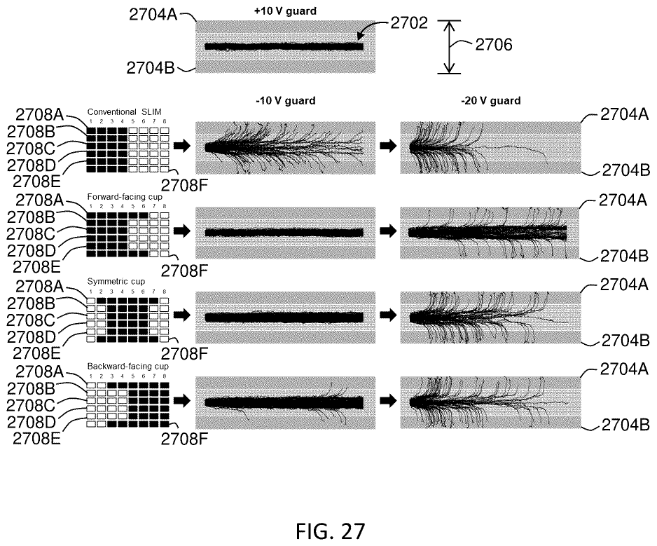

The ability of traveling cups to confine ions was evaluated using a “traveling wall” SLIM with guard electrodes (and 6TW, 5RF geometry) and applying negative voltages to the guard electrodes. Negative guard voltages may cause ions to be lost under traveling wall SLIM conditions, but the simulations provide qualitative insight into the application of larger duty cycle rectangular waves to the outer TW electrodes. Ion trajectory simulations were performed with a 50% duty cycle rectangular wave applied to all TW electrodes and applying +10 V_{DC} to the guard electrodes (TW frequency=14 kHz, RF=300V at 1 MHz, pressure=2.3 Torr nitrogen, m/z=+466.5, 100 ions). A snapshot of the ion trajectory obtained using these parameters is shown in FIG. 27. As illustrated in the example of FIG. 27, no ions 2702 are lost to guard electrodes 2704A, 2704B, and the distribution of ions 2702 in vertical dimension 2706 is narrow. Next, the guard voltage was changed to −10 V_{DC} and the ion trajectory simulations were repeated while all other parameters were unchanged. The results of these ion trajectory simulations is shown in FIG. 27. As expected, almost all of the 100 ions 2702 were lost to the guard electrodes 2704A, 2704B before they traverse the full simulation space. The losses occur even earlier when −20 V_{DC} is applied to the guard electrodes 2704A, 2704B. A snapshot of the ion trajectories obtained using −20 V_{DC} is shown in FIG. 27. These results indicate that negative guard voltages cause ion losses.

### B. Forward-Facing Traveling Cups

Next, ion trajectory simulations were performed using forward-facing traveling cups (75% duty cycle applied to the outermost TW electrode tracks—illustrated schematically at 2708A and 2708F in FIGS. 27, 50% duty cycle applied to the innermost TW electrode tracks—illustrated schematically at 2708B-2708E) while applying −10 V_{DC} to the guard electrodes 2704A and 2704B. A snapshot of this ion trajectory simulation is shown in FIG. 27. In this example, ions 2702 moved through the simulation space without being lost to the electrodes 2704A and 2704B. This is despite a negative guard voltage. This demonstrates that applying higher duty cycles to the outer TW electrode tracks 2708A and 2708F (e.g., 75%) can confine ions 2702 to the ion pathway even in the presence of a perturbing force (i.e., negative potential for positive ions). To determine how strong the confining force from the higher duty cycles was, another ion trajectory simulation was performed using −20 V_{DC}.

This guard voltage caused many ions to be lost to the guard electrodes 2704A and 2704B, although some ions 2702 successfully traversed the simulation space. A snapshot of the ion trajectory simulation using −20 V_{DC} is shown in FIG. 27.

### C. Symmetric Traveling Cups

Ion trajectory simulations were performed using symmetric traveling cups (75% duty cycle applied to the outermost TW electrode tracks 2708A and 2708F, 50% duty cycle applied to the innermost TW electrode tracks 2708B-2708E) while applying −10 V_{DC} and −20 V_{DC} to the guard electrodes 2704A and 2704B. Snapshots are shown in FIG. 27. The results are similar to those obtained for the forward-facing cups. Ions 2702 were confined across the entire simulation space when using −10 V_{DC} guard voltages but lost when using −20 V_{DC} guard voltages. The ion trajectory simulations using the symmetric cup and −20 V_{DC} guard voltage were lost earlier than when forward-facing traveling cups were used. This suggests that the forward-facing traveling cups may confine ions with greater efficiency than the symmetric traveling cups.

### D. Backward-Facing Traveling Cups

Ion trajectory simulations were performed using backward-facing traveling cups (75% duty cycle applied to the outermost TW electrode tracks 2708A and 2708F, 50% duty cycle applied to the innermost TW electrode tracks 2708B-2708E) while applying −10 V_{DC} and −20 V_{DC} to the guard electrodes 2704A and 2704B. Snapshots are shown in FIG. 27, respectively. Ions 2702 were confined in the presence of −10 V_{DC} guard voltages but lost very early when using −20 V_{DC} guard voltages. These qualitative simulations appear to suggest that all three waveform profiles are able to confine ions in the presence of a −10 V_{DC} guard voltages, but as suggested by the results obtained when using-20 V_{DC} guard voltages, the forward-facing traveling cups appear to confine ions more strongly than the symmetric traveling cups, and both the forward-facing and symmetric traveling cups appear to confine ions more strongly than the backward-facing traveling cups.

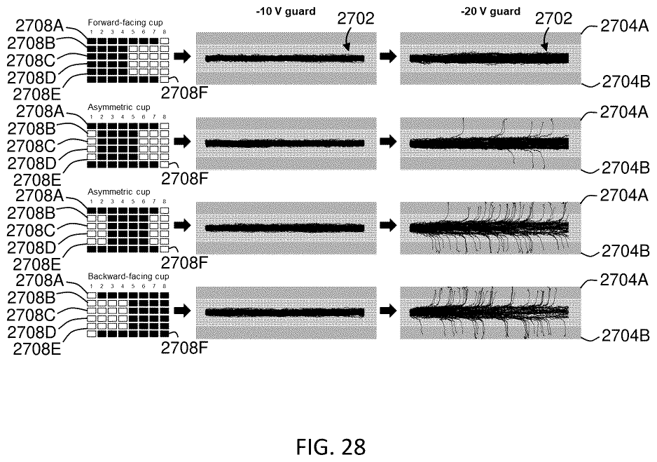

The entire set of ion trajectory simulations was repeated while applying 87.5% duty cycle rectangular waves to the outermost TW electrode tracks 2708A and 2708F and 50% rectangular waves to the innermost TW electrode tracks 2708B-2708E. Snapshots obtained using forward-facing, one configuration of asymmetric cups, a second configuration of asymmetric cups, and backward-facing cups in the presence of −10 V_{DC} and −20 V_{DC} guard voltages are shown in FIG. 28, respectively. Similar behavior to the previous ion trajectory simulations was obtained. All waveform profiles fully confined ions when −10 V_{DC} guard voltages where applied.

Interestingly, ions were lost when −20 V_{DC} guard voltages were used in all but the forward-facing cup. Some ions were lost when using the first asymmetric cup configuration. Additional ions were lost when using the second asymmetric cup configuration. Even more ions were lost when using the backward-facing cup.

### E. Adjacent Ion Tracks

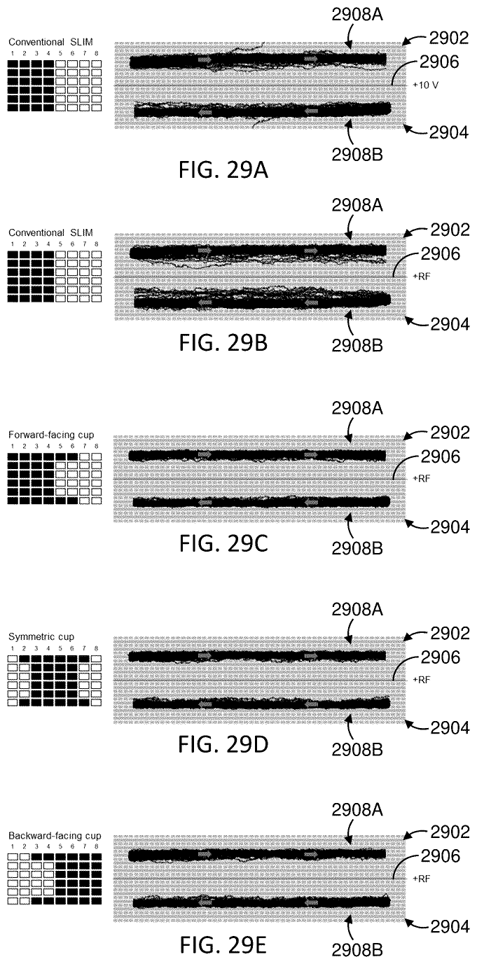

To further evaluate whether the traveling cups can be used to confine ions to a more realistic ion pathway, two ion pathways were simulated adjacent to each other to determine if ions jump tracks when they traverse straight regions (i.e., not turns). A snapshot of this simulation space is provided in FIG. 29A. A top ion pathway 2902 possessed traveling waves that moved from left to right. A bottom ion pathway 2904 possessed traveling waves that moved from right to left.

The ion pathways 2902, 2904 were separated by a long electrode 2906. Different voltages (e.g., DC and/or RF) can be applied to this electrode 2906 to explore their effects. No guard electrodes were generated for these simulations.

The ion trajectory simulation shown in FIG. 29A was performed by applying traveling wave parameters (e.g., 50% duty cycle rectangular wave) to the electrode tracks forming each ion pathway but applying +10 V to the middle electrode 2906 separating the tracks. This simulation depicts a SLIM with a 0.4 mm guard electrode as the middle electrode 2906. As can be seen, ions 2908A, 2908B from the top ion pathway 2902 and bottom ion pathway 2904 never cross. However, a few ions were lost to the peripheries of the simulation space. This implies that no confining force exists to keep ions confined to the ion pathways 2902, 2904 except for the middle electrode 2906, but it also means that SLIM separations can be performed using a narrow guard electrode (if no U-turns are used to create a serpentine path, discussed later).

The ion trajectory simulations were repeated using an RF voltage at the middle electrode (instead of a DC guard voltage). A snapshot of the ion trajectory simulation using these parameters is shown in FIG. 29B. This simulation showed once again that ions do not jump to adjacent pathways.

The ion trajectory simulations (RF on the middle electrode 2906) were then repeated using forward-facing, symmetric, and backward-facing traveling waves (75% DC outer, 50% DC inner). Snapshots of these ion trajectory simulations are shown in FIG. 29C, FIG. 29D, and FIG. 29E. No ions were observed to jump to the adjacent pathway in these simulations either, which is a positive finding.

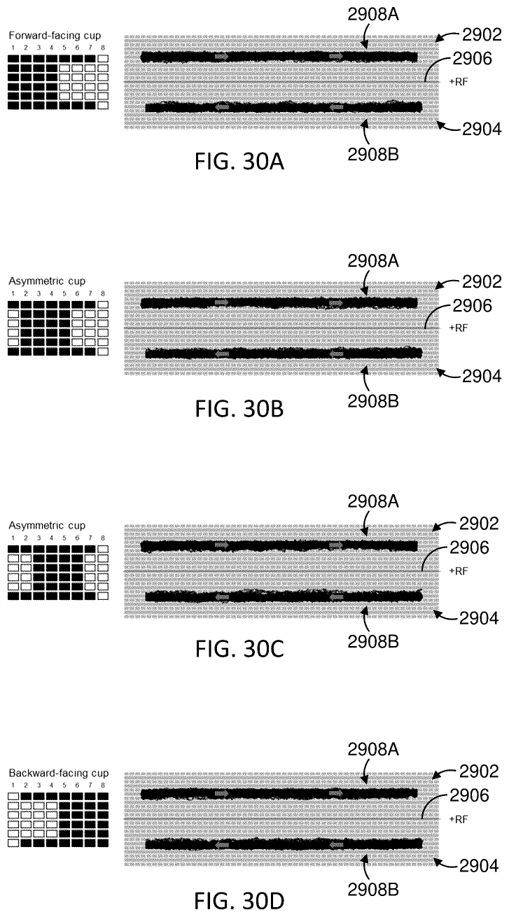

The set of ion trajectory simulations was also repeated using forward-facing, asymmetric, and backward-facing traveling waves when 87.5% duty cycle rectangular waves were applied to the outermost TW electrode tracks of each pathway (with 50% DC on one or more inner track(s)). Snapshots of these ion trajectory simulations are shown in FIG. 30A (forward-facing cup), FIG. 30B (first configuration of asymmetric cup), FIG. 30C (second configuration of asymmetric cup), and FIG. 30D (backward-facing cup).

This indicates that ions do not jump to adjacent ion pathways. However, in some aspects, different traveling wave profiles (e.g., forward-facing, symmetric, backward-facing) can be used to ensure ions do not become lost to the edges of the ion pathway (i.e., where no adjacent pathway exists at the periphery of the IM device).

### F. Ion Trajectory Simulations with U-Turns

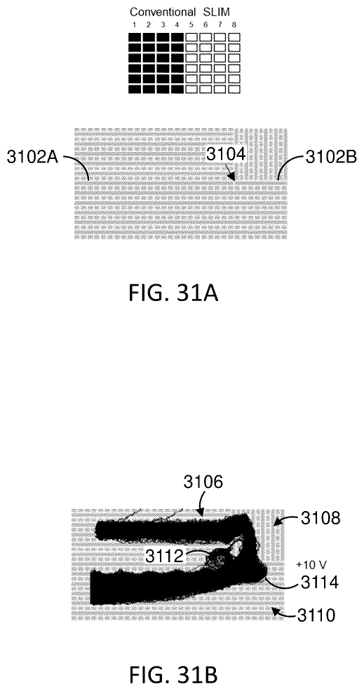

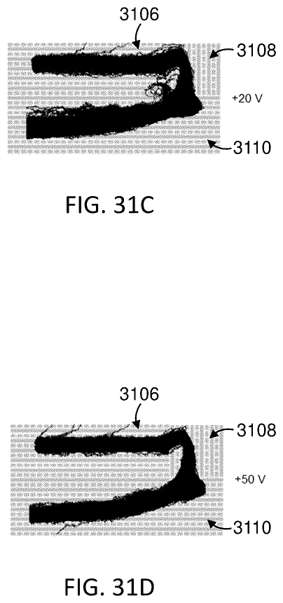

Ion trajectory simulations were also performed for ions traversing a U-turn using traveling wall and traveling cup waveforms. The simulation workspace was designed to be similar to the workspace of FIGS. 29 and 30 that utilized the two adjacent ion pathways. However, the U-turn design placed a 90° turn at the end of the top pathway and extended the bottom pathway. A snapshot of the simulation workspace without any ion trajectories is shown in FIG. 31A. Note that a middle RF electrode was segmented into two electrodes 3102A, 3102B instead of keeping it as one continuous electrode. A black arrow 3104 in FIG. 31A points to the location where the electrodes 3102A, 3102B are separated. This segment was done so that different voltages could be applied to the segment 3102A on the left while keeping an RF voltage on the segment 3102B to the right.

The first set of ion trajectory simulations traversing the U-turn were performed using different positive guard voltages applied to the left portion 3102A of the middle electrode. Snapshots of the ion trajectories obtained using +10 V, +20 V, and +50 V voltages applied to the left portion of the middle electrode are shown in FIG. 31B, FIG. 31C, and FIG. 31D. When +10 V was applied to the middle electrode, ions 3106 traveled from left to right and entered a first 90° turn 3108, albeit with a few losses along the way. However, the ions 3106 had difficulty entering a second 90° turn 3110 as shown by circles 3112 formed near the middle of the workspace and the protrusion regions 3114 at the bottom right side of the workspace. Both features are indicative of ions excessively rolling over the traveling waves at the second 90° turn 3110. This effect can lead to peak broadening and ion losses. Since the formation of circles 3112 near the middle electrode indicates that the repelling force created by +10 V is not strong enough to repel ions, the voltage was increased to +20 V. Increasing the voltage to +20 V slightly improved ion transmission through the U-turn, but ions still exhibited excessive rollover events at the second 90° turn 3110. Further increasing the voltage to +50 V also improved ion transmission through the U-turn to the extent that no circles were formed near the middle of the workspace. However, protrusions still occurred near the bottom right of the workspace.

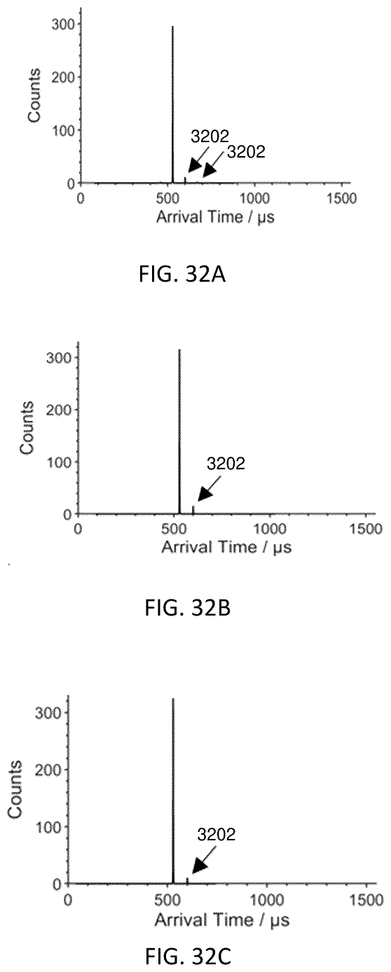

To evaluate the extent to which the +DC voltages affected ion transmission through the U-turn, arrival time distributions of 1000-ion trajectory simulations performed using +10, +20, and +50 V were plotted as shown in FIG. 32A-C. As can be seen, all three DC voltages caused ions to exhibit several peaks (indicated by the black arrows 3202), which indicates rollover events. The number of rollover events decreased when voltage was increased from +10 V to +20 V to +50 V. Nevertheless, rollover events occurred even when +50 V was used.

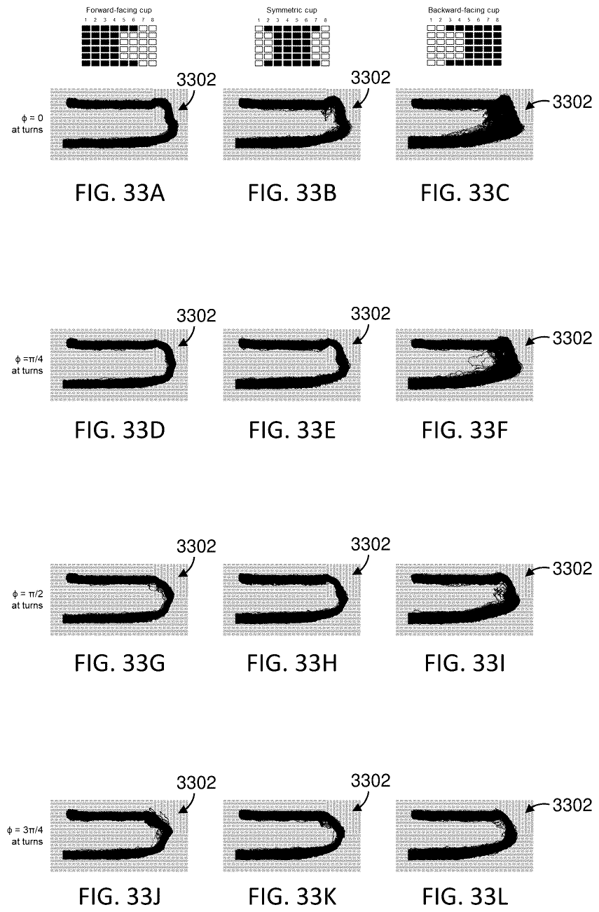

Snapshots of the ion trajectory simulations obtained using forward-facing, symmetric, and backward-facing traveling cups are shown in FIG. 33A, FIG. 33B, and FIG. 33C, respectively. The most notable feature of these snapshots is that the forward-facing traveling cup appears to move ions through the U-turn 3302 without the previously observed circles 3112 of FIG. 31B near the middle of the workspace or protrusions 3114 near the bottom right of FIG. 31B. This is indicative of efficient ion transfer through the U-turn 3302.

Ions did not move into each 90° region at an orthogonal angle. Rather, they moved towards the edge of the workspace slightly before resuming their travel to the next region of the ion track. The results from the forward-facing traveling cups were markedly different than those obtained when using the symmetric traveling cups. Several ions traveling through the U-turn when using the symmetric traveling cups exhibited circular motions prior entering the first 90° region, which indicated inefficient transfer. The circular motions worsened when using the backward-facing cups to move ions through the U-turn. It became difficult to discern any specific ion motion through the U-turn because ions seemingly get stuck at both interfaces between the 90° regions.

Ion trajectory simulations were performed using the forward-facing, symmetric, and backward-facing traveling cups to move ions through a U-turn, only this time the waveforms were phase shifted at each 90° turn. For example, if the phase of one traveling cup was +0 when applied to the top track, the phase of the traveling cups at the first 90° turn would be +π/4, and the phase of the traveling cups at the second 90° turn would be an additional +π/4 (+π/2 compared to the top track).

Snapshots of the ion trajectories performed using forward-facing, symmetric, and backward-facing traveling cups using +π/4, +π/2, and +3π/4 phase shifts at each 90° turn are shown in: (+π/4) FIG. 33D, FIG. 33E, FIG. 33F; (+π/2) FIG. 33G, FIG. 33H, FIG. 33I; (+3π/4) FIG. 33J, FIG. 33K, and FIG. 33L. The ion trajectories obtained when using forward-facing traveling cups and phase shifts of +π/4 at each 90° turn were typical of the trajectories obtained when simulating ions traversing a U-turn in a SLIM system. Specifically, ions enter each 90° turn at a mostly orthogonal angle and do not exhibit any circular motions or protrusions. Increasing the phase shift of the forward-facing traveling cups to +π/2 and +3π/4 resulted in ions tending to exhibit more circular motions at the first 90° turn. Furthermore, the ion trajectories became more distorted when using larger phase shifts at the 90° turns, and the trajectories obtained when using +3π/4 showed a “V” shape at the U-turn.

The ion trajectories obtained when using the symmetric traveling cups appeared to become more efficient (e.g., resulting in less ion loss) when phase shifts were employed at the 90° turns. For example, circular motions were observed when no phase shift was applied at turns, but these motions went away when using +π/4 and +π/2 phase shifts. However, the circular motions returned when +3π/4 phase shifts were used.

The ion trajectories obtained when using backwards-facing traveling cups retained circular motions at the first 90° turn, though the number of circles was reduced when larger phase shifts were used. Accordingly, the backwards-facing traveling cups may be more efficient for straight-track ion paths than U-turns.

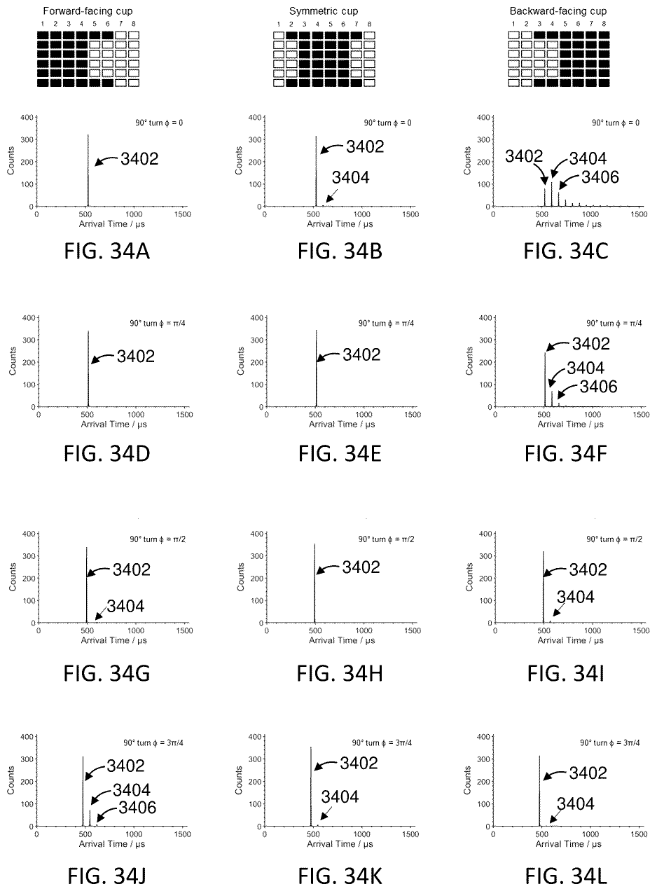

Lastly, the extent to which the forward-facing, symmetric, and backward-facing traveling cups affected ion transmission through the U-turn was evaluated by plotting the arrival time distributions of the 1000-ion trajectory simulations. The arrival time distributions for the forward-facing traveling cups obtained using four different phase shifts at the 90° turns are shown in FIG. 34A, FIG. 34B, FIG. 34C, and FIG. 34D. The arrival time distributions for the symmetric traveling cups obtained using four different phase shifts at the 90° turns are shown in FIG. 34E, FIG. 34F, FIG. 34G, and FIG. 34H. The arrival time distributions for the backward-facing traveling cups obtained using four different phase shifts at the 90° turns are shown in FIG. 34I, FIG. 34J, FIG. 34K, and FIG. 34L. As can be seen, the forward-facing traveling cups produced a single distribution 3402 of arrival times when phase shifts of +0 and +π/4 were applied to the 90° turns. Another small distribution 3404 was observed when the phase shift applied to the 90° turns was increased to +π/2. Furthermore, a third distribution 3406 was observed when the phase shift applied to the 90° turns was increased to +3π/4, and the number of ions in the second distribution also increased. In this manner, the forward-facing traveling cups can successfully transfer ions through 90° turns when using +0 and +π/4 applied to the 90° turns. The arrival time distributions obtained when using the symmetric traveling cups showed two distributions when +0 and +3π/4 phase shifts were applied to the 90° turns. However, a single distribution was obtained when +π/4 and +π/2 phase shifts were used. Accordingly, the symmetric traveling cups can also successfully transfer ions through 90° turns with phase shifts of +π/4 and +π/2. However, the backward-facing traveling cups produced two or more distributions regardless of the phase shift used at the U-turns.

In view of the many possible embodiments to which the principles of the disclosed technology may be applied, it should be recognized that the illustrated embodiments are only preferred examples and should not be taken as limiting the scope of the invention. Rather, the scope of the disclosed technology is defined by the following claims. We therefore claim all that comes within the scope of these claims.

We claim:

1. An ion mobility device, comprising:
an ion pathway;
a plurality of segmented electrodes arranged in an array that comprises three or more tracks of segmented electrodes, wherein the plurality of segmented electrodes is configured to receive time-varying DC voltages to move ions along the ion pathway; and
a controller configured to:
charge the plurality of segmented electrodes with a waveform on at least one outer track of the array that is different from a waveform on an inner track of the array to provide at least some lateral confinement of the ions as the ions are moved along the ion pathway.

2. The ion mobility device of claim 1, wherein the waveform on the at least one outer track of the array has a duty cycle that is different from the waveform on the inner track of the array.

3. The ion mobility device of claim 2, wherein the duty cycle on the at least one outer track of the array is greater than the duty cycle on the inner track of the array.

4. The ion mobility device of claim 2, wherein the controller is further configured to apply an intermediate duty cycle to an intermediate track located between the at least one outer track of the array and the inner track of the array.

5. The ion mobility device of claim 1, wherein the plurality of segmented electrodes are charged with waveforms having different phase shifts, and wherein the phase shifts are incremented in units of π/4.

6. The ion mobility device of claim 1, wherein the controller is configured to form traveling wave sets that extend to move ions along the ion pathway.

7. The ion mobility device of claim 1, further comprising a plurality of guard electrodes positioned laterally relative to the segmented electrodes, wherein the plurality of guard electrodes is configured to provide additional lateral confinement of the ions to the ion pathway.

8. The ion mobility device of claim 1, further comprising a plurality of radiofrequency (RF) electrodes configured to confine ions to the ion pathway, wherein the controller is configured to apply RF power to the plurality of RF electrodes to prevent ions from approaching the RF electrodes and thereby provide additional lateral confinement of the ions to the ion pathway.

9. The ion mobility device of claim 1, wherein the ion pathway comprises adjacent first and second legs and a connecting bend.

10. The ion mobility device of claim 9, wherein the first and second legs are separated laterally by a distance that is less than half a width of the first and/or second leg.

11. An ion mobility device, comprising:
an electrode arrangement including adjacent first and second legs and a connecting bend that define an ion pathway, wherein the electrode arrangement includes traveling wave sets that extend to move ions along the ion pathway;
wherein the first and second legs are separated laterally by a distance that is less than half a width of the first and/or second leg.

12. The ion mobility device of claim 11, wherein the electrode arrangement comprises a plurality of segmented electrodes arranged in an array that comprises three or more tracks of segmented electrodes, and wherein the traveling wave sets comprise a duty cycle on at least one outer track of the array that is different from a duty cycle on an inner track of the array to provide at least some lateral confinement of the ions as the ions are moved along the ion pathway.

13. The ion mobility device of claim 12, wherein the duty cycle on the at least one outer track of the array is greater than the duty cycle on the inner track of the array.

14. The ion mobility device of claim 12, wherein the duty cycle on the inner track of the array comprises a duty cycle of 50% or less, and wherein the duty cycle on the at least one outer track of the array comprises a duty cycle of greater than 50%.

15. The ion mobility device of claim 12, wherein the plurality of segmented electrodes are charged with waveforms having different phase shifts, and wherein the phase shifts are incremented in units of π/4.

16. The ion mobility device of claim 11, further comprising a plurality of guard electrodes positioned laterally relative to the ion pathway, wherein the plurality of guard electrodes is configured to provide additional lateral confinement of the ions to the ion pathway.

17. The ion mobility device of claim 11, wherein the first and second legs are separated laterally by a distance that is less than half a width of the first and/or second leg.

18. A method comprising:
moving ions along an ion pathway, wherein the ion pathway is defined by an array of segmented electrodes that comprises three or more tracks of segmented electrodes extending along a direction of the ion pathway; and
at least partially laterally confining the ions as the ions are moved along the ion pathway through the application of different duty cycles to different tracks of the segmented electrode array.

19. The method of claim 18, wherein at least partially laterally confining the ions comprises applying a duty cycle on at least one outer track of the array that is greater than a duty cycle on an inner track of the array.

20. The method of claim 19, wherein applying the duty cycle on the at least one outer track of the array comprises applying a duty cycle of greater than 50%, and wherein applying the duty cycle on the inner track of the array comprises applying a duty cycle of 50% or less.
